(19) United States
(12) Patent Application Publication
(10) Pub. No.: US 2011/0145653 A1
(43) Pub. Date: Jun. 16, 2011

(54) METHOD AND SYSTEM FOR TESTING COMPLEX MACHINE CONTROL SOFTWARE

(75) Inventors: Guy Broadfoot, Arendonk (GB); Leon Bouwmeester, Vm Helmond (NL); Philippa Hopcroft, Surrey (GB); Jos Langen, Cc Zetten (NL); Ladislau Posta, Eindhoven (RO)

(73) Assignee: Verum Holding B.V., LA te Waaire (NL)

(21) Appl. No.: 13/058,292

(22) PCT Filed: Aug. 14, 2009
(86) PCT No.: PCT/GB2009/051028

§ 371 Date: Feb. 9, 2011

(30) Foreign Application Priority Data
Aug. 15, 2008 (GB) 0814994.0
Jun. 25, 2009 (GB) 0911044.6

(51) Int. Cl. G06F 11/36

(52) U.S. Cl. 714/38.1; 714/E11.217

(57) ABSTRACT

A method and system for testing complex machine control software A method of formally testing a complex machine control software program in order to determine defects within the software program is described. The software program to be tested (SUT) has a defined test boundary, encompassing the complete set of visible behaviour of the SUT, and at least one interface between the SUT and an external component, the at least one interface being defined in a formal, mathematically verified interface specification. The method comprises: obtaining a usage model for specifying the externally visible behaviour of the SUT as a plurality of usage scenarios, on the basis of the verified interface specification; verifying the usage model, using a usage model verifier, to generate a verified usage model of the total set of observable, expected behaviour of a compliant SUT with respect to its interfaces; extracting, using a sequence extractor, a plurality of test sequences from the verified usage model; executing, using a test execution means, a plurality of test cases corresponding to the plurality of test sequences; monitoring the externally visible behaviour of the SUT as the plurality of test sequences are executed; and comparing the monitored externally visible behaviour with an expected behaviour of the SUT.

### FIELD OF THE INVENTION

The present invention relates to a method and system for testing complex machine control software to identify errors/defects in the control software. More specifically, though not exclusively, the present invention is directed to improving the efficiency and effectiveness of error-testing complex embedded machine control software (typically comprising millions of lines of code) within an industrial environment.

### BACKGROUND ART

It has become increasing common for machines of all types to contain complex embedded software to control operation of the machine or sub-systems of the machine. Examples of such complex machines include: x-ray tomography machines; wafer steppers; automotive engines; nuclear reactors, aircraft control systems; and any software-controlled device.

It has become increasingly common for important product characteristics previously engineered mechanically or electronically to now be realised by means of functional performance of the machine controlled by software. Therefore, the impact of such software on the correct operation and performance of such machines is increasing. Defects in such software cause machine failure and can have important safety consequences for the users of such machines.

The nature of such software is very complex. Such software is event driven meaning that it must react to external events. Control software is reactive and must remain responsive to external events over which it has no control whenever they occur and within predefined reaction times. Such software is concurrent and must be able to control many actions and processes in parallel. Software of this type is very large, ranging in size from tens of thousand of source lines to tens of millions of source lines. For example, a modern wafer stepper is controlled by approximately 12 million source lines of control software; a modern cardiovascular X-Ray machine is controlled by approximately 17 million source lines of control software; and a modern car may have as many as 100 million sources lines of control software being executed by 50 to 60 interconnected processor elements. Control software may be safety critical meaning that software failures can result in severe economic loss, human injury or loss of life. Examples of safety critical applications include control software for piloting an aircraft, medical equipment, and nuclear reactors. The externally observable functional behaviour of such software is non-deterministic. It is axiomatic in computer science that non-deterministic software cannot be tested; that is, the total absence of all defects cannot be proven by testing alone, no matter how extensive.

In the current software industry, software is most commonly designed and tested using ‘informal’ methods as described below. Common current practice for testing complex embedded control software is shown in FIG. 1. During the design of the software, human design engineers write or express, at step 10, the required behaviour of the software. This is often referred to as a specification of the system. However, there are no strict rules governing the language or expressions used. As such, these written specifications are typically ‘informal’ in the sense described above. They are typically imprecise, incomplete and inconsistent, and frequently contain errors. This means that the specified behaviour is open to misinterpretation by the test engineer.

Human test engineers analyse, at step 12, the written specifications of the required behaviour and performance of the software to be tested. On the basis of the specification analysis, the test engineers must define, at step 14, sufficient test sequences, each of which is a sequence of actions that the software under test (SUT) must be able to perform correctly to establish confidence that the software will operate correctly under all operating conditions.

The test sequences are typically translated, at step 16, by hand to test cases which can be executed automatically. These test cases may be expressed in the form of high-level test scripts describing a sequence of steps in a special purpose scripting language or programmed directly in a general purpose programming language as executable test programs.

The test cases are executed and the results recorded, at step 18. The software is modified to correct detected faults and the test cases are rerun. This continues until, in the subjective judgement of the test engineers, the software appears to be of sufficient quality to release.

It is widely and commonly recognised that existing practice suffers from a great number of disadvantages. Firstly, there are too few test cases for results to be statistically meaningful. Testing is an exercise in sampling; the ‘population’ being sampled is the set of all possible execution scenarios of the software being tested and the ‘sample’ is the total set of test cases being executed. In the case of testing of the complexity and size described above, the population is uncountable and unimaginably large. Therefore, in the case of conventional practice, the sample of test cases produced is too small to be of any statistical significance.

In addition, test sequences are currently constructed by hand. This means that the economic cost (and elapsed time) of producing test cases increases linearly with the number of test cases. This makes it economically infeasible to generate sufficiently large sets of test cases so as to be statistically meaningful.

Due to the size and complexity of industrial software and the disadvantages inherent in informal specifications, a high proportion of erroneous test programs are produced, there is no way of manually verifying that all test scripts are indeed valid execution paths through the software under test (SUT) and the testing environment. As a result, handling erroneous test scripts is time consuming, particularly if the SUT is large.

Furthermore, there is no guarantee that the sample has been taken from a complete population group; in other words, that the complete functionality has been sampled. As such, a relatively small portion of the software system's functionality may be tested, but other functions may be completely missed.

Using conventional testing methods, the SUT is tested in such a way that the test environment and the real environment in which the SUT normally operates cannot be distinguished from each other. This implies that the test environment must contain models of the real environment, and which are specific to the SUT, but these environmental models may be invalid. It is not possible to guarantee that these models are correct, and results from such testing cannot be relied upon.

There is no properly quantified measure for the amount of testing needed. One of the most difficult problems during testing is to know when to stop, because the absence of observed faults to a certain point does not guarantee the complete absence of faults. In conventional testing, two metrics are used, these are called the ‘test coverage’ and the ‘defect influx rate’.

The test coverage is intended to represent the amount of testing carried out as a percentage of the total number of tests which would be needed to test every possible execution scenario. As above, it is impossible to quantify the total number of execution scenarios. As a result, proxy measures are used for which there is little mathematical basis. Examples of the proxy measures used are 1) the percentage of the executable statements that have been executed at least once or 2) the percentage of the functions or use cases that have been covered by the test programs. In reality, such metrics tell us nothing about the probability of an error occurring during the long term operational use of the SUT.

The defect influx rate represents the number of defects found during testing. Commonly, when the curve representing this metric flattens, the software is released. It is clear from the above that both measures fail to distinguish between the quality of the testing process as opposed to the quality of the software being tested.

In addition, there is no proper correlation between the number of hand written test cases and the level of confidence that can be garnered regarding the reliability of the SUT. A linear increase in the probability of finding a defect requires an exponential increase in the number of test cases.

Furthermore, there is typically no or limited traceability between the informal specifications describing the test environment and interfaces, the SUT and the results of failures reported during the execution of the test programs.

As a result, it is common for testing to require a substantial part of the software development cycle and budget, typically 50% or more, while only yielding a small degree of confidence regarding the reliability of the software. Furthermore, given the likelihood of having invalid test cases and/or having incomplete functionality and/or having invalid environmental models increases the uncertainty of releasing software with the required reliability. Thus, despite the testing effort, such software is frequently released with a large number of undiscovered defects.

In summary, in conventional software testing systems, all specifications of the functional requirements of the SUT and test scripts are described as “informal” with the meaning as specified above. Consequently, no conclusions can be drawn regarding the accuracy and coverage of the set of testing scripts, and no guarantee can be given regarding the proportion of test scripts that are erroneous.

An object of the present invention is to alleviate at least some of the above-described problems associated with conventional methods for testing software systems, for completeness and correctness.

### SUMMARY OF INVENTION

According to one aspect of the present invention, there is provided a method of formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the method comprising: obtaining a usage model for specifying the externally visible behaviour of the SUT as a plurality of usage scenarios, on the basis of the verified interface specification; verifying the usage model, using a usage model verifier, to generate a verified usage model of the total set of observable, expected behaviour of a compliant SUT with respect to its interfaces; extracting, using a sequence extractor, a plurality of test sequences from the verified usage model; executing, using a test execution means, a plurality of test cases corresponding to the plurality of test sequences; monitoring the externally visible behaviour of the SUT as the plurality of test sequences are executed; and comparing the monitored externally visible behaviour with an expected behaviour of the SUT.

The present invention overcomes many of the problems associated with the prior art by bringing the testing into the formal domain. This is achieved by mathematically verifying using formal methods the usage model of the SUT with respect to its at least one interface. Once this is done the verified usage model can be used, with suitable conversion, to create a plurality of test sequences that ultimately can be used to generate a plurality of test cases for testing the SUT. Unexpected responses can indicate defects in the SUT. Furthermore, as testing is practically non-exhaustive, the testing can be carried out to accord with a statistically reliable measure such as a level of confidence.

One embodiment of the present invention comprises a system called a Compliance Testing Framework (CTF) that integrates into the conventional software testing system, as illustrated in FIG. 6. The purpose of compliance testing is to verify by testing that a given implementation complies with the specified externally visible behaviour, i.e. that it behaves according to the set of interface specifications. Importantly, these interface specifications are ‘formalised’ so that they can be mathematically verified to be complete and correct.

Advantageously, compliance testing results in a statistical reliability measure, specifying the probability that any given sequence of input stimuli will be processed correctly as specified by the interface specifications.

It is useful to plan the testing process in order to determine the required software reliability level and the confidence levels, by selecting which tests to run, and to identify the resources needed for performing these tests. The required software reliability level and the confidence levels input into the CTF become constraints that the SUT must comply with in order to complete the testing process.

The present invention provides a system and method that enables a statistical reliability measure to be derived, specifying the probability that any given sequence of input stimuli will be processed correctly by the SUT as specified by its interface. The present invention guarantees that the Usage Model from which the test sequences are generated is complete and correct with respect to the interfaces of the SUT. Furthermore, the present invention enables the Usage Model to be automatically converted into a Markov model, which is enables generation of test sequences and hence test cases.

The present invention can be arranged to provide fully automated report generation that is fully traceable to the interface specifications of the SUT.

Due to the completeness and correctness guarantee, described above, the present invention provides a clear completion point when testing can be stopped. As a result, both the actual and perceived quality of the SUT is much higher. The actual quality is much higher as it is guaranteed that the generated test cases are correct and therefore potential defects are immediately traceable to the SUT. Furthermore, the amount of (generated) test cases is much higher than in conventional testing. Consequently, the likelihood of finding defects is also much higher. The perceived quality is also much higher as testing is performed according to the expected usage of the system.

All test case programs are generated by the present invention automatically. Therefore, using the CTF system, for example, it is possible to generate a small set of test case programs as well as a very large set of test case programs which are then statistically meaningful. Furthermore, only the usage model needs to be constructed manually once and maintained in case of changes to the component interfaces. The economic cost and elapsed time to generate test cases are then a constant factor. This makes it economically feasible to generate very large test sets.

Since Usage Models are verified for correctness, it is guaranteed that only valid test cases will be generated: each generated test case will obey the given component interface(s) that was used to verify the usage model.

Since Usage Models are also verified for completeness, the CTF system, for example, can guarantee that all behaviour required of a compliant SUT is captured: there is no behaviour in the component interfaces required of a compliant SUT which is not in the usage models.

When statistical tests are employed, by analysing statistical data, it is possible to determine whether a SUT has been sufficiently tested. Using a required reliability level and a required confidence level, the estimated number of test case programs can be calculated beforehand. Once all test case programs have been executed, it can be determined whether the required reliability level has been met and thus whether testing can be stopped.

The environmental models can be represented by adapters components. The interfaces to these adapter components are exactly the same as the formal interface specifications of the real world components that they represent. Using the standard ASD technology it is now possible to verify these adapters components for correctness and completeness.

Once testing is stopped, the measured reliability level is known. Given the required confidence level, it is then also possible to calculate the lower bound reliability level. In other words, the SUT will at least have a reliability, which is equal or higher than the lower bound reliability level.

In case of non-compliance, the CTF system, for example, advantageously automatically provides a sequence of steps that have been performed to the point where the SUT has failed. This allows an easy reproducibility of these failures. As a result, the CTF system can provide an economic way in terms of time and costs to release products that have a higher quality by both objective and subjective assessments.

The present invention may be configured to handle non-deterministic ordering and occurrences of events sent by the system-under-test. In addition, the present invention is able to reconcile different test boundaries introduced by the decoupling of asynchronous messages via a queue. Furthermore, the handling of events sent by the system-under-test that may or may not occur and can be labelled as ignorable within the test environment.

The SUT preferably has a plurality of interfaces for enabling communication to and from a plurality of external components, the plurality of interfaces being specified formally as sequence based specifications. This enables more complex control software to be tested.

The obtaining step may comprise obtaining a usage model which specifies the usage model in sequence based specification (SBS) notation within enumeration tables, each row of a table identifying one stimulus, its response and its equivalence for a particular usage scenario. Also the obtaining step may comprises obtaining a usage model in which the SBS notation has been extended, in the enumeration tables, to include one or more probability columns to enable advantageously the usage model to represent multiple usage scenarios.

The SBS notation may be extended, in the enumeration tables, to specify a label definition, such that when particular usage scenario in the usage table results in non-deterministic behaviour, each label definition has a particular action associated therewith to resolve the non-deterministic behaviour. This enables the method to handle certain types of non-deterministic behaviour of the SUT.

The SBS notation may also be extended, in the enumeration tables, to specify a label reference, such that when a particular usage scenario in the usage table results in non-deterministic behaviour, each label reference has a corresponding label definition within the enumeration table for resolving the non-deterministic behaviour. This is a useful way of the method enabling multiple references to a commonly used action in response to non-deterministic behaviour.

The obtaining step may further comprise obtaining a usage model which specifies an ignore set of allowable responses to identify events which may be ignored during execution of the test cases, depending on a current state in the usage model. This enables “allowed responses” to be identified in the Usage Model which enables generated test case programs to distinguish between responses of the SUT which must comply exactly with those specified in the Usage Model from those which may or ignored.

The verifying step may comprise: generating a corresponding mathematical model from the usage model and the plurality of formalised interface specifications; and testing whether the mathematical model is complete and correct. This is an efficient way of verifying the correctness of the usage model. Thereafter, the testing step may comprise checking the mathematical model against a plurality of well-formedness rules that are implemented through a model checker.

The method may further comprise translating the usage model into a Markov model representation, which is free of history and predicate information such that in any given present state, all future and past states are independent of the present state. This enables the representation to be used directly by a sequence extractor. The extracting step may use Graph Theory for extracting the set of test sequences.

The extracting step may further comprise extracting a minimal coverage test set of test sequences, which specify paths through the usage model, the paths visiting every node and causing execution of every transition in the usage model.

Advantageously, the executing step may comprise executing a plurality of test cases which correspond to the minimal coverage test set of test sequences and the comparing step may comprise comparing the monitored externally visible behaviour of the SUT to the expected behaviour of the SUT for full coverage of all transitions in the usage model. This advantageously ensures that all of the possible state transitions are covered by the test cases. Thereafter the extracting step may further comprise extracting a random test set of test sequences, the selection of the random test set of test sequences being weighted in dependence on specified probabilities of the usage scenarios occurring during operation. This random set of test cases is chosen to determine the level of confidence in the testing.

The executing step may further comprise executing the random test set and the comparing step may comprise comparing the monitored externally visible behaviour of the SUT to the expected behaviour of the SUT

The random test set may be sufficiently large in order to provide a statistically significant measure of the reliability of the SUT, the size of the random test set being determined as a function of a user- specified reliability and confidence level.

The method may further comprise converting the extracted set of test sequences into a set of executable test cases in an automatically executable language. Preferably the automatically executable language is a programming language or an interpretable scripting language, such as Perl or Python.

The executing step may comprise routing the plurality of test cases through a test router, the test router being arranged to route call instructions from the plurality of test cases to a corresponding one of the plurality of interfaces of the SUT.

The method may further comprise generating the test router automatically on the basis of the formal interface specifications for the plurality of interfaces to the SUT which cross the defined test boundary.

The method may further comprise specifying the test router formally as a sequence based specification, which is verified for completeness and correctness.

The method may further comprise developing a plurality of adapter components to emulate the behaviour of a corresponding external component which the SUT communicates with, wherein the adapter components are specified formally as sequence based specifications, which are verified for completeness and correctness.

The test boundary may be defined as being the boundary at which the test sequences are generated and at which test sequences are executed, and the method may further comprise establishing the test boundary at an output side of a queue which decouples call-back responses from the external components to the SUT. Alternatively the method may further comprise establishing the test boundary at an input side of a queue which decouples call-back responses from the external components to the SUT.

In the further alternative, the test boundary when defined as a test boundary where the tests are generated, and when defined as a test and measurement boundary where the test sequences are executed, may be located at different positions with respect to the SUT, and the method may further comprise monitoring signal events which indicate when the SUT removes events from a queue which decouples call-back responses from the external components to the SUT, in order to synchronise test case execution, and using the removed events to reconcile the difference between the test boundary and the test and measurement boundary to ensure that these boundaries are matched.

The method may further comprise generating, from the verified usage model and a plurality of used interface specifications, a tree walker graph in which paths through graph describe every possible allowable sequence of events between the SUT and its environment, wherein a used interface is an interface between the SUT and its environment. In this case the method may further comprise considering events in the test sequence, traversing the tree walker graph in response to events received in response to execution of the test sequence, and distinguishing between ignorable events arriving at allowable moments which can be discarded, required events arriving at expected moments and which cause the test execution to proceed and events that are sent by the SUT when they are not allowed according to the tree walker graph of the interface, which represent noncompliant behaviour.

The method may further comprise receiving an out of sequence (i.e. receiving an event in the wrong order or “out of order”) event from the SUT that is defined in the tree walker graph as allowable and storing the out of sequence event in a buffer or queue. The method may further comprise checking the buffer each time the test sequence requires an event from the SUT, to ascertain whether the event has already arrived out of sequence, and when an event has arrived out of sequence, removing that event from the buffer as though the event has just been sent, and proceeding with the test sequence.

The executing step may further comprise receiving valid and invalid test data sets, and using a data handler to ensure that test scenarios and subsequent executable test cases operate on realistic data during test execution.

The executable test cases may comprise a plurality of test steps, and the method may further comprise logging all the test steps of all the test cases in log reports in order to provide traceable results regarding the compliance of the SUT. In this case, the method may further comprise: collating the data from the log reports of all the test cases from a random test set; and generating a test report from the collated data.

The method may further comprise accumulating statistical data from the test report; and calculating a software reliability measure for the SUT.

The comparing step may further comprise: determining when the testing method may end by comparing a calculated software reliability measure against a required reliability and confidence level.

According to another aspect of the present invention there is provided a system for formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the system comprising: a usage model specifying the externally visible behaviour of the SUT as a plurality of usage scenarios, on the basis of the verified interface specification; a usage model verifier for verifying the usage model to generate a verified usage model of the total set of observable, required behaviour of a compliant SUT with respect to its interfaces; a sequence extractor for extracting a plurality of test sequences from the verified usage model; a test execution means for executing a plurality of test cases corresponding to the plurality of test sequences; a test monitor means for monitoring the externally visible behaviour of the SUT as the plurality of test sequences are executed; and a test analyser for comparing the monitored externally visible behaviour with an expected behaviour of the SUT

According to another aspect of the present invention, there is provided a system for automatically generating a series of test cases for use in formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the system comprising: a usage model specifying the externally visible behaviour of the SUT as a plurality of usage scenarios, on the basis of the verified interface specification; a usage model verifier for verifying the usage model to generate a verified usage model of the total set of observable, expected behaviour of a compliant SUT with respect to its interfaces; a Markov model generator for generating a Markov model of the verified usage model; a sequence extractor for extracting a plurality of test sequences from the verified usage model; and a test execution means for executing a plurality of test cases on the SUT corresponding to the plurality of test sequences.

According to another aspect of the present invention there is provided a method of testing a complex machine control software program (SUT) which exhibits non-deterministic behaviour in order to determine defects within the software program, wherein the software program to be tested (SUT) has a defined test boundary encompassing both the complete set of visible behaviour of the SUT and at least one interface between the SUT and an external component, the at least one interface being defined in a formal, mathematically verified interface specification, the method comprising mathematically verifying a usage model, which specifies the externally visible behaviour of the SUT as a plurality of usage scenarios, on the basis of the verified interface specification, and generating a verified usage model of the total set of observable, expected behaviour of a compliant SUT with respect to its interfaces; wherein some forms of non-deterministic behaviour are accommodated by providing actions to the interface for each non-deterministic event which force the SUT to adopt a particular deterministic response, extracting, using a sequence extractor, a plurality of test sequences from the verified usage model; executing, using a test execution means, a plurality of test cases corresponding to the plurality of test sequences.

According to another aspect of the present invention there is provided a method of testing for defects in a complex machine control program the method including the step of modelling an interface with a queue for handling non-deterministic behaviour.

According to another aspect of the present invention there is provided a method for analysing test results obtained from testing a complex machine control software program (SUT), the method comprising generating a tree walker graph from the verified usage model and a plurality of used interface specifications of interfaces between the SUT and its environment, wherein the tree walker graph defines a plurality of paths which describe every possible allowable sequence of events between the SUT and its environment, traversing the tree walker graph in accordance to events received in response to execution of a test sequence, and distinguishing between ignorable events arriving at allowable moments which can be discarded, required events arriving at expected moments and which cause the test execution to proceed, and events that are sent by the SUT when they are not allowed according to the tree walker graph of the interface, which represent noncompliant behaviour.

The method may further comprise receiving an out of sequence (i.e. receiving an event in the wrong order or “out of order”) event from the SUT that is defined in the tree walker graph as allowable and storing the out of sequence event in a buffer or queue. The method may further comprise checking the buffer each time the test sequence requires an event from the SUT, to ascertain whether the event has already arrived out of sequence, and when an event has arrived out of sequence, removing that event from the buffer as though the event has just been sent, and proceeding with the test sequence.

### BRIEF DESCRIPTION OF DRAWINGS

In the drawings:

FIG. 1 (prior art) is flowchart providing an overview of the method steps of a conventional software testing process;

FIG. 2 (prior art) is a schematic block diagram of a software system under test (SUT) showing a test boundary between components of the testing environment and the SUT;

FIG. 3 (prior art) is a schematic block diagram of an operation context of the SUT of FIG. 2, where the operational context is a home entertainment system;

FIG. 4 (prior art) is a schematic block diagram of the components of the conventional software testing process of FIG. 1;

FIG. 5 (prior art) is a more detailed flowchart of the method steps of FIG. 1;

FIG. 6 is a flowchart of the method steps of a software testing process according to one embodiment of the present invention;

FIG. 7 is a schematic block diagram showing the interaction of a compliance test framework (CTF), for carrying out the method steps of FIG. 6, and the SUT;

FIG. 8 is a schematic block diagram showing the test environment of the SUT, and the interconnections between components of the CTF and the SUT;

FIG. 9 is a representation of components of an actual SUT and a usage model created as part of the process of FIG. 6;

FIG. 10 is a development of the representation of FIG. 9 showing the context of a client-server architecture decoupled by a queue;

FIG. 11 is a development of the representation of FIG. 9 showing the definition of an input-queue test boundary;

FIG. 12 is an alternative representation to FIG. 12 showing the definition of an output-queue test boundary;

FIG. 13 is a development of the representation of FIG. 9 showing the usage model defined on the input-queue test boundary;

FIG. 14 is a development of the representation of FIG. 9 showing the usage model defined on the output-queue test boundary;

FIG. 15 is schematic representation of a test and measurement boundary defined between the CTF and the SUT, according to one embodiment of the present invention;

FIG. 16a is a graphical representation of a simplistic ‘mealy’ state machine representing a usage model;

FIG. 16b is a graphical representation of a predicate expanded usage model expanded from FIG. 16a;

FIG. 16c is a graphical representation of a TML model converted from the predicate expanded usage model of FIG. 16b;

FIG. 17 is a tabular representation of an extract from a usage model;

FIG. 18 is an portion of a state diagram showing the effects o non-determinism;

FIG. 19 is a functional block diagram of the components of the CTF shown in FIG. 7, including a data handler;

FIGS. 20a to 20d is a more detailed flowchart of the method steps of FIG. 6;

FIGS. 21 to 23 are flowcharts showing the method steps of the data handler of FIG. 19;

FIGS. 24a to 24d are flowcharts representing algorithms performed by the data handler of FIG. 19 for data validation functions and data constructor functions;

FIG. 25 is a state diagram for a simple example usage model for illustrating a set of test sequences which may be generated from this usage model; and

FIG. 26 is a representation of a usage chain and a testing chain, which assist in the explanation of the “Kullback Discriminant” which is one method for determining when testing may be stopped.

### DETAILED DESCRIPTION OF PREFERRED EMBODIMENTS

Prior to describing specific embodiments of the present invention, it is important to expand on the understanding given previously about how the prior art methods of testing such software worked. This understanding also helps to understand better the context of the present invention and enables direct comparisons of corresponding functional parts. This is now explained with specific reference to FIGS. 2 to 5 of the accompanying drawings.

The SUT, is the control software for a given complex machine, which to be tested. In order to effect this testing, it is necessary to determine the boundary of what is being tested (referred to as a test boundary), and to model the behaviour of the SUT, in relation to the other components of the system in order to ascertain if the actual behaviour of the system as it is being tested matches the expected behaviour from the model. FIG. 2 exemplifies the SUT 30 in an operational context. As shown, the SUT is operationally connected to additional components, shown as client, DEV1, DEV2, and DEV3. Between the SUT 30 and the devices in the system are a plurality of interfaces ISUT, IDEV1, IDEV2, and IDEV3. The ISUT is client interface to the SUT. IDEV1, IDEV2, IDEV3 are the interfaces between the SUT and three devices it is controlling.

The SUT 30 may in a normal operational context, communicate with another system element (Client) 32 which uses the functions of the SUT and which accesses them via the client interface ISUT 34. In any given system, the Client 32 can be software, hardware, some other complete software/hardware system or a human operator. There may be one such Client 32 or there may be many or none. In any given system, the interface ISUT 34 may be realised by a set of interfaces with different names; in this example, the set of interfaces is referred to as ISUT and this term may be taken to represent a set of one or more client interfaces.

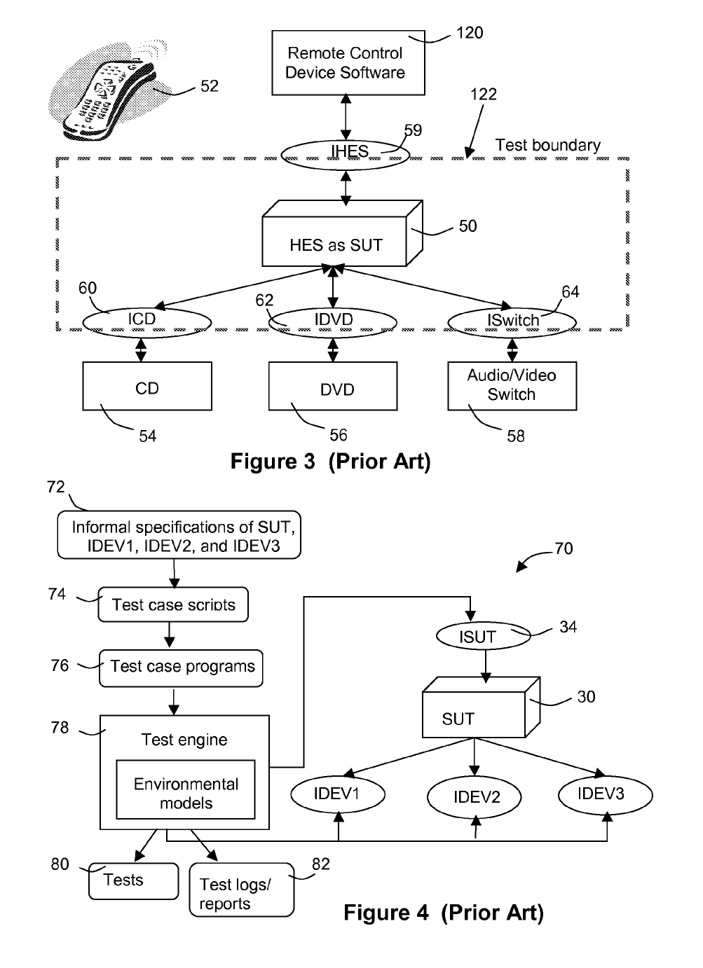

An example of a system comprising control software which is to be tested is shown in FIG. 3, and relates to control software for a home entertainment system (HES) 50, which takes input from a user interface 52 (for example a remote control), and provides control signals to the devices of the system (i.e. a CD player 54, DVD player 56, or an audio/visual switch 58 for passing control signals to audio or visual equipment as necessary). In this example, commands received from the remote control 52 are translated into control signals by the control software (i.e. the SUT), and control signals from the devices (CD or DVD player 54, 56) are communicated to the audio/visual equipment (i.e. a TV and/or loud speakers) via the audio/visual switch 58 which is also controlled by the control software (SUT) 50.

The commands may include, for example, selecting one or other of the devices, changing volume levels, or selecting operations to be carried out, i.e. ejecting, playing or pausing a disc. For each command, the SUT 50 is expected to behave in a certain manner, and it is the behaviour of the SUT, and the devices/interfaces it interacts with which must be modelled in order to ascertain if the SUT is behaving correctly, i.e. if the software is operating correctly.

In other words, the SUT must be modelled to understand the expected behaviour/output from any given input, and the environment within which the SUT operates in must also be modelled in order to be able to provide or receive communications signals generated from or expected by the SUT.

In FIG. 3, the SUT 50 receives commands from the remote control 52, via the client interface IHES 59 and controls the devices CD 54, DVD 56 and Audio/Visual Switch 58 via their respective interfaces ICD 60, IDVD 62 and ISwitch 64. A person skilled in the art will appreciate that any given system, there may be fewer or more than three devices being controlled and these may be other software elements, hardware elements or complete software/hardware systems or subsystems.

In order to test the SUT 50, it is necessary to gain an understanding regarding the externally visible behaviour of the SUT 50 and of the interfaces, IHES 59, ICD 60, IDVD 62 and ISwitch 64. In this sense there is no fundamental difference between the client interface 59 and the device interfaces 60, 62, 64, they are simply interfaces through which the SUT 50 communicates with the other components in the system.

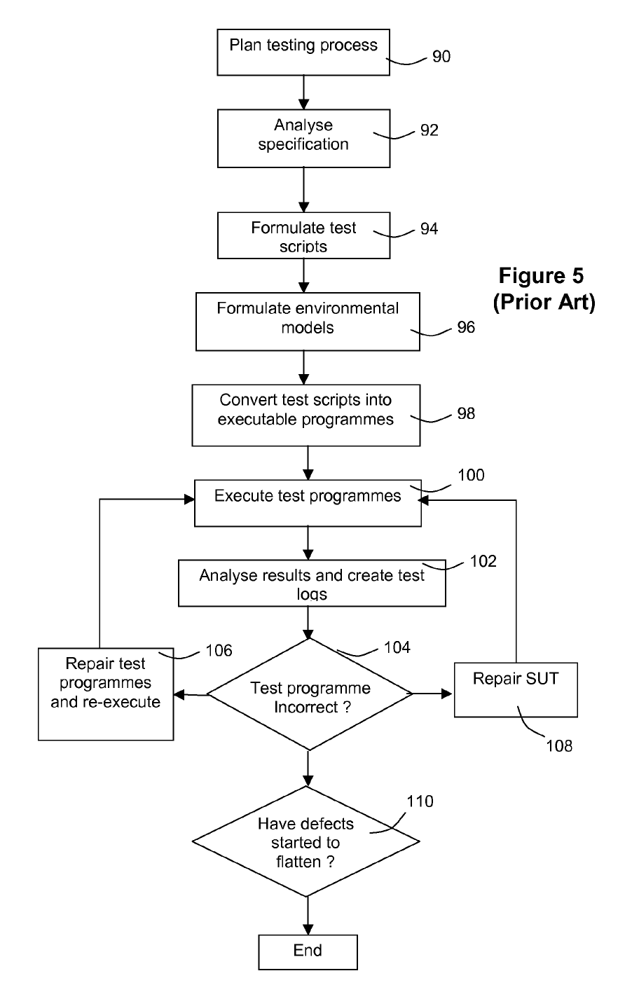

FIG. 4 shows the functional components within a conventional software testing system 70 commonly used in industry in more detail. The functional components are, as described above, the SUT 30, and the interfaces ISUT 32, IDEV1, IDEV2, and IDEV3. In addition, the conventional system includes Informal Specifications 72 of IDEV1, IDEV2, IDEV3 and ISUT. These specifications are the natural language, informal functional specifications of the interfaces between the Client and the three controlled devices. Collectively, these informal specifications attempt to describe the entire externally visible behaviour of the SUT 30 which is to be verified by testing.

The conventional testing system 70 uses test case scripts 74. Each test case script is a high level description of a single test case, prepared manually by a Test Engineer, based on an analysis of the informal specifications 72. For example, in the above home entertainment system, expected behaviour may include operations such as opening the CD drawer when the eject button is pressed, and closing the CD drawer either i) when the eject button is hit again, ii) after a predetermined time, or iii) at power down. Therefore, a test case script would be generated to test this functionality to check that the HES behaves as intended.

Collectively, the test case scripts 74 attempt to describe the complete set of tests to be executed. Each test case script describes a sequence of interactions with the SUT 30 which tests some specific part of its specified behaviour. The total set of test case scripts would ideally be sufficient to establish confidence that the software will operate correctly under all operating conditions. However, as described above, this is often not the case with informal testing methods.

From the test scripts 74, test programs 76 are created. Test programs 76 are the executable forms of the test scripts 74, and are generated by Test Engineers by hand or by using software tools designed for this purpose. The test engine 78 in FIG. 4 is a software program or combination of hardware and software that executes the test programs one by one, logs the results, and creates the test logs/reports. The test engine 78 acts as both the Client and the controlled devices of the SUT in such a manner indistinguishable from the real operational environment.

The Client and the controlled devices are not shown in FIG. 4 because they are outside the test boundary and therefore not part of the SUT. In other words, the SUT is tested independently of the Client and devices. It is not desirable at the time of testing the SUT to permit the control signals to be passed to the devices, since any errors in the software could lead to unwanted behaviour, and possible damage of the devices. For example, the control software being tested may be for expensive machinery, which could be driven erroneously in such a way as to cause damage.

The test engine 78 and the test case programs 76 should combine to provide the functionality of the Client and the controlled devices to the SUT in a manner indistinguishable from the real operational context. The outcome of the testing process are the tests 80 which were executed and test reports 82 which are report files recording details of test execution, for example, which tests were executed and whether or not they succeeded or failed.

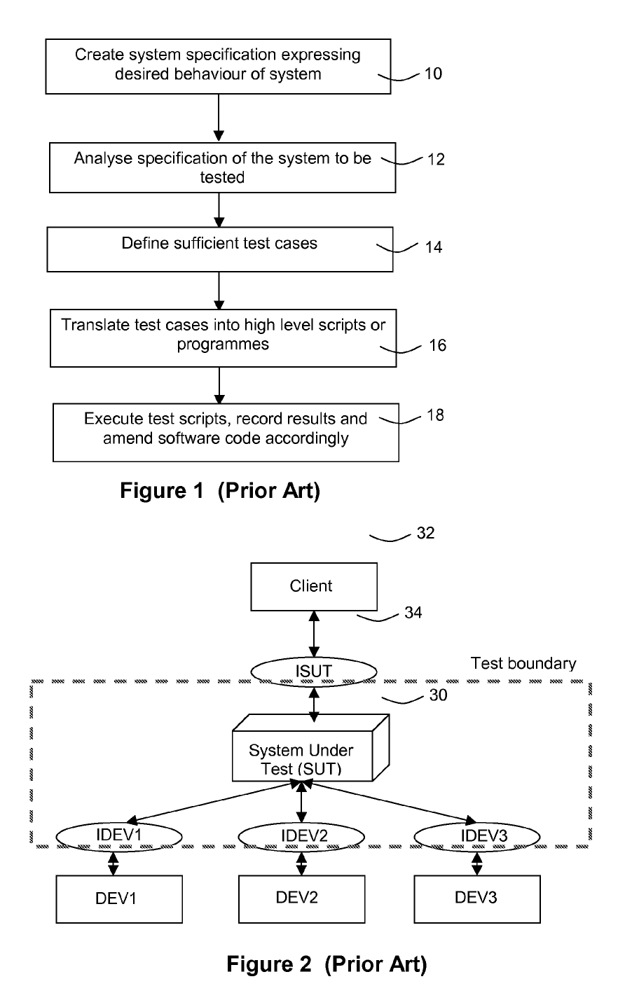

FIG. 5 is a flowchart of the steps in a conventional software testing process commonly used in industry. FIG. 5 is a more detailed example of the summary shown in FIG. 1 and includes the following steps. The testing process is planned, at step 90, by investigating which areas of the SUT require testing, and by identifying the resources needed for performing these tests. The informal specification of the functional behaviour of the SUT is analysed, at step 92. The functional behaviour of the SUT is described by its Client interfaces and the interfaces to the controlled devices. A set of test scripts is formulated, at step 94, by hand. In addition, a set of environmental models is formulated, at step 96, by hand.

The test scripts are converted, at step 98, into executable test programs. This may be achieved manually or automatically, if a suitable tool exists. The executable test programs are run, at step 100, using the test engine and the SUT, which generates test results for each executed test. The test results are analysed and test logs are created, at step 102. The test logs 82 indicated defects for those test programs that have failed to execute successfully. For each failure, the test engineer must determine, at step 104, if the failure is due to the SUT or if the test program was incorrect. Test failures due to incorrect test programs are common because in the conventional testing process, there is no way of verifying that every test is a valid test. Where test failures are caused by invalid test programs, the test scripts and test programs are repaired, at step 106, and the process continues, at step 100. Alternatively, where failures are due to errors in the SUT, the SUT will be repaired, at step 108, and the process then continues, at Step 100. The curve representing the in-flux of the defects is analysed, at step 110, and the SUT is typically released when the curve starts to flatten.

As described above, there are many problems associated with the conventional methods for testing software. Notably, it is expensive and time consuming to test industrial scale, complex control software. It is not possible to ascertain statistically meaningful test results and as a result, it is common for such software to be released with a large number of undiscovered defects and for these to remain undetected for months or even years.

In part, the problems associated with how software is tested relate to how software is traditionally designed. As described in detail in the International patent application, WO2005/106649, entitled “Analytical Software Design System” filed on 5 May 2005 (the contents of which are incorporated herein by reference), it is not possible during the design of software systems to verify the design itself is correct and complete.

To help alleviate some of these problems associated with software design, ‘formal’ design methods have been developed. A formal design method comprises a mathematically based notation for specifying software and/or hardware systems, and mathematically based semantics and techniques for developing such specifications and reasoning about their correctness. An example of a formal method is the process algebra CSP as used in the Analytical Software Design system described in WO2005/106649, in which correctly running code is automatically generated from designs which have been mathematically verified for correctness. In such cases, the automatically generated code does not need to be tested, as it has been generated from mathematically verified designs in such a way that the generated code is guaranteed to have the same runtime behaviour as the design. All software development methods which are not formal in the sense described above are called informal or informal methods.

A formal specification is one specified using a formal method. An informal specification is one resulting from an informal method and is commonly written in a natural language such as English with or without supporting diagrams and drawings.

In practice, however, when formal methods are used to design software, those methods are rarely applied to the design of all software in a system. It is usual that such systems contain at least some elements developed using informal methods, for example, legacy code (existing code with which new code must be able to function alongside and interact) and off-the-shelf software components written by third parties. Such software elements have not therefore been mathematically proven to be correct and must rely on testing. Similarly, total software systems constructed of verified software elements combined with unverified software elements require rigorous testing within an execution environment equivalent to that in which the software must operate in situ.

The present invention provides an improved method and system for testing control software, which develops the formal design methodology further to provide statistically meaningful test results.

Returning to the operational context of the software testing system in FIG. 3, the overall system comprises: a CD player 54; a DVD player 56; an AudioVideo switch 58, for routing the output of the DVD and CD player to the audio/visual components (not shown) of the system; a software component for the Home Entertainment System (HES) 50, which is the overall control software for the complete Home Entertainment System and is the software (SUT) to be tested; an interface 59 to the Remote Control consisting of an infra-red link with hardware detectors (not shown); and a software component called Remote Control Device Software 120 which processes and controls all signals from the Remote Control 52 and passes them to the HES control software 50.

The dashed line 122 represents the System Test Boundary. Everything outside that boundary is called the test environment; everything inside that boundary is part of the SUT 50. The oval shapes through which the dashed line 122 passes represent the entire set of interfaces through which elements in the environment communicate and control the SUT.

Commands received from the Remote Control 52 are passed to the SUT via the interface IHES 59. In response, the SUT is supposed to instruct the CD player 54 or DVD player 56 via the corresponding interfaces ICD 60 and IDVD 62 to carry out the corresponding actions and to instruct the AudioVideo switch 58 via ISwitch 64 to route the audio/visual output of the CD player or DVD player to the rest of the system.

The testing environment must i) behave exactly like the Remote Control and its associated software communicating to the SUT via the IHES interface; ii) behave exactly like the CD player 54, DVD player 56 and AudioVideo switch 58 devices when the SUT 50 communicates via the ICD 60, IDVD 62 and ISwitch 64 interfaces; and iii) must be able to carry out test sequences on the SUT 50 and monitor the resulting SUT behaviour across all test system boundary interfaces. The testing environment must behave in such a way that the SUT 50 cannot distinguish it from the real operational environment.

As described in detail below, the positioning of the test boundary has an impact on the different test cases which may be used to prove correctness of the SUT 50.

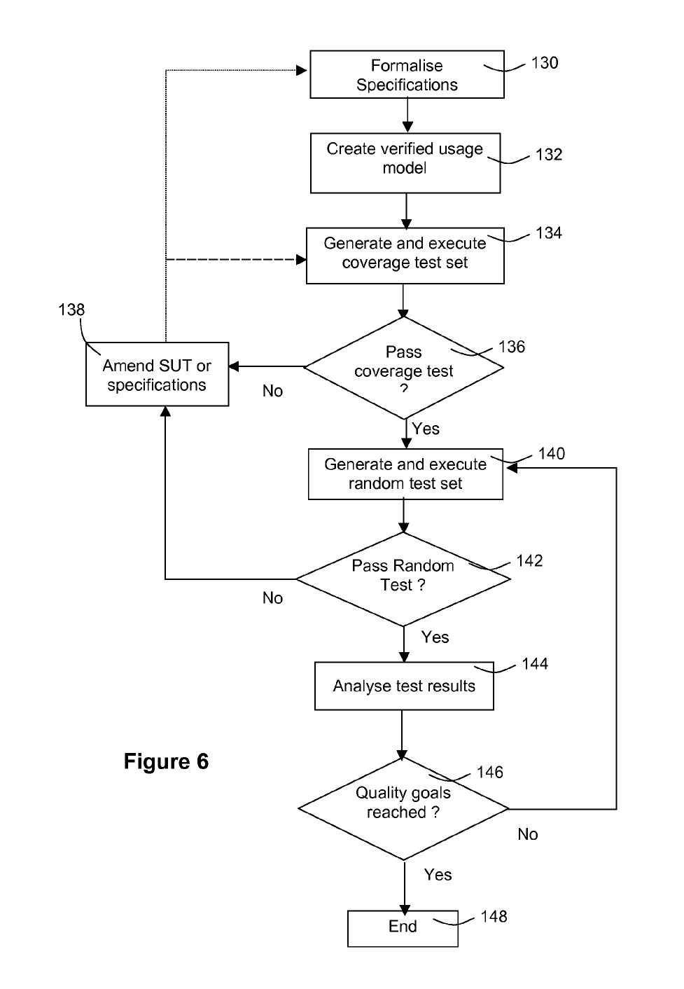

An overview of the method steps of the testing process according to one embodiment of the present invention is shown in FIG. 6. This overview is a high-level description of the processes required and is intended to provide relevant background to the invention such that the theory behind many of the principles on which one aspect of the invention is based may be explained. A detailed embodiment according to this aspect of the invention is described in detail after the theoretic principles relating to test boundaries, usage models, and non-determinism are explained.

At the start of the process, the informal specifications for all of the interfaces between the SUT and the testing environment are formalised, at step 130. This is a manual process in which a skilled person analyses the informal specifications and translates them into specifications in the form of an extended Sequence Based Specifications (SBS) as described below.

Sequence-Based Specifications, as described in the Analytical Software Design system described in WO2005/106649, provide a method for producing consistent, complete, and traceably correct software specifications. In the SBS method, a sequence enumeration procedure and the results can be converted to state machines and other formal representations. The aim of the SBS notation is to assist in generating models of the use of the SUT rather than modelling the SUT itself. SBS notation advantageously provides a rich body of information which gives an “engineering basis” for testing and for planning and managing testing. SBS will be well known to a person skilled in the art and so the underlying principles are not described in detail in this specification. However, any variations in the SBS notation for the purpose of explaining the present invention are described in more detail later.

In one embodiment, if the interfaces have not been formally specified previously, the interfaces are specified ‘formally’ using SBS for the first time as part of the testing process. However, a person skilled in the art will appreciate that during design of the SUT (as part of the design process) one or more of the interfaces may have been previously expressed in a formal specification, and these formal SBS specifications may already be available for use during the testing phase of a SUT.

When the interfaces have been formally specified using SBS notation, the CTF testing system is arranged to create, at step 132, a verified usage model that specifies the use (behaviour) of the system to be tested completely. Completeness in this sense means that the usage model expresses all possible states, stimuli and responses that correspond with how the system is intended to behave.

From the usage model, a coverage test set and corresponding test programs are generated, at step 134, in order to test whether the actual behaviour of the system matches the expected behaviour. The coverage test set is a representative minimal set of tests that executes each transition in the usage model at least once. Further information concerning usage models is provided below.

The system is arranged to automate the execution of the generated test programs, and determines, at step 136, if the SUT has passed the coverage test. If the SUT has not passed, the results of the tests will specify where the errors exist. In one scenario, the errors may be within the SUT, which will need to be resolved in order to pass the coverage test. Alternatively, it is possible that errors may exist in the specifications as a result of errors introduced at conception of the design. For example, a misunderstanding in the principles behind the specification (i.e. how a particular process is intended to function) could lead to an error by the software designer during the creation of the formal specifications. It should be noted that these specifications are mathematically verified to be correct, and the errors are not a result of how the specifications are created, but are introduced as the specifications are created.

Depending on the errors identified, the specifications or the SUT are corrected, at step 138, and subsequently either the specifications are created and formalised again, at step 130, or the coverage test set is executed again, at step 134.

When the coverage test has been passed, the CTF system is arranged to generate and execute, at step 140, a random test set. A random test set is a set of test programs selected according to statistical principles which ensure that the test set represents a statistically meaningful sample of the total functionality being tested. Each generated random test set is unique and is executed only on one specified version of the SUT.

The system is arranged to automate the execution of the generated random test programs, and determines, at step 142 if the SUT has passed the random test. If the SUT has not passed, the results of the tests will specify where the errors exist. Again, it is possible that errors may exist in the specifications or the SUT. Depending on the errors identified, the specifications or the SUT are again corrected, at step 138. Every time errors are detected and repaired, a new Random Test Set is generated in order to test the new version of the SUT.

When the results of the random test set indicate a ‘pass’, the system analyses, at step 144, the test results in order to determine, at step 146, if it is possible to stop the testing process because the required confidence level and reliability has been achieved. If the answer is no, the additional random test sets are generated and executed, at step 142, and the process is repeated until the answer is yes. When the answer is yes, the testing process ends, at step 148.

In one embodiment, the same test programs may be rerun, at steps 134 or 136, as a regression test set to check that, in addressing one failure, no new errors have been introduced into the SUT. However, after these regression tests have been executed it is necessary to again generate, at step 134 or 136, new test cases in order to ensure statistically meaningful test results.

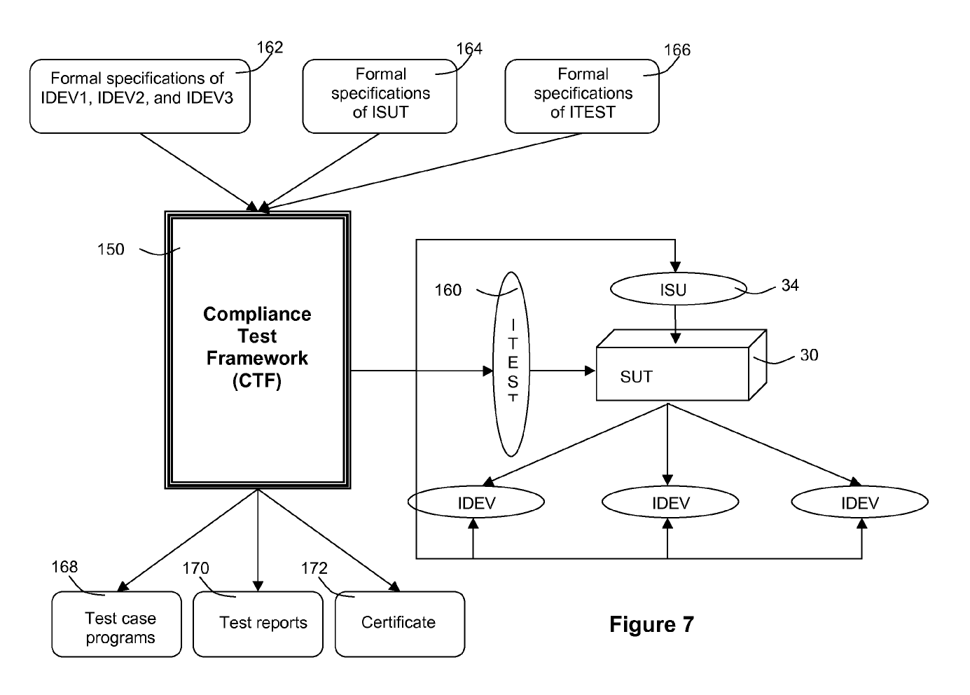

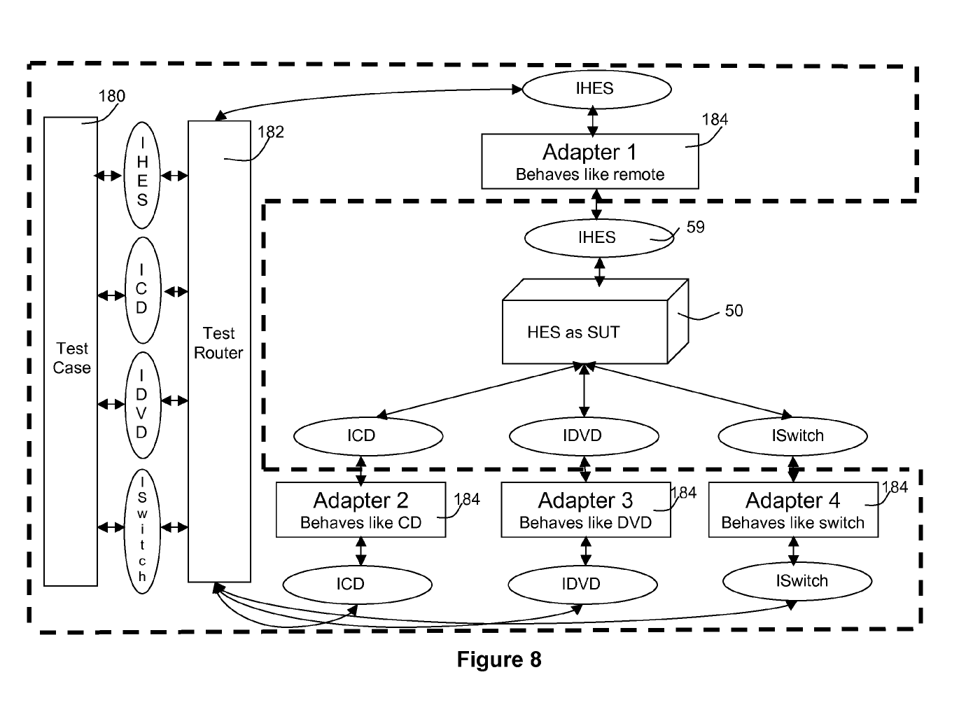

A functional block diagram of a software testing system 150, also called a Compliance Test Framework (CTF), according to one embodiment of the present invention, and a SUT is shown in FIG. 7.

The CTF 150 interacts with the SUT 30 and ISUT, which are components having the same meaning as described above. Also shown are examples of interfaces, IDEV1, IDEV2, IDEV3 between the SUT and the devices it controls.

The CTF 150 comprises a special set of interfaces (ITEST) 160 to the SUT specifically for testing purposes. These interfaces 160 are analogous to the test points and diagnostic connectors commonly designed into PCBs. They provide special functions not present on the ISUT, IDEV1, IDEV2 or IDEV3 interfaces that enable the testing, and to force the SUT into specific ‘states’ for the purposes of testing.

The interfaces between the SUT and the “DEV” adapters in FIG. 8 are all “Used Interfaces”. A used interface is an interface between the SUT and its environment. It is an interface to things in the operational runtime environment that the SUT depends on as opposed to “Client Interfaces” or “Implemented Interfaces” which are implemented by behaviour in the SUT. “Used Interfaces” are each specified in the form of an ASD Interface Model.

The inputs to the CTF 150 include formal mathematically verified specifications of IDEV1, IDEV2, IDEV3 (162), ISUT (164) and ITEST (166). These are ASD Interface Models (as described in Analytical Software Design system described in WO2005/106649) of the externally visible behaviour of the SUT as it is visible at the interfaces. Collectively these models form a complete and unambiguous mathematical description of all the relevant interfaces and represent the agreed behaviour that the SUT has to adhere to across the interfaces.

As described above, the formal specifications may be previously defined as part of the design process for the component. For example, one of the devices may have been designed using the formal technique of the Analytical Software Design system described in WO2005/106649. Alternatively, the components (SUT, DEV1, DEV2, or DEV3) may not have been specified formally prior to the creation of the testing framework, i.e. for example where the testing is of a legacy system designed and created using informal design techniques. However, for the purposes of testing the software using the CTF system of one embodiment of the present invention, it is irrelevant whether the interface specifications have been created previously, as this step can be carried out as part of the testing process.

The output from the CTF includes test case programs 168, which are sets of executable test case programs each of which executes a test sequence representing a test case. These test sets are automatically generated by the CTF and are a valid sample of the total coverage or functionality of the SUT. The number of test case programs generated is determined according to statistical principles depending on the chosen confidence and reliability levels.

The CTF system also outputs test reports 170, which are report files recording details of the test case programs executed. In other words, a report of all the tests that were executed and whether or not they succeeded or failed, is output.

Based on the results as described in the test reports, the SUT may be certified, and certificates 172 can be produced automatically. All of these inputs and outputs are stored in corresponding sections of a CTF database (not shown).

The test environment is shown in detail in FIG. 8. The test environment shown is similar to that of the prior art (shown in FIG. 3) thought the details and differences are now expanded upon. As above, the oval shapes represent interfaces and the rectangular shapes represent components of the CTF system 150.

The test environment of FIG. 8 includes a plurality of functional blocks of the test environment, including: a test case 180, comprising a plurality of instructions and test data to test the functionality of the SUT; a test router 182, for routing the instructions and test data from the test case to the test environment; and a plurality of adapters (Adapters 1 to 4) 184, for emulating the behaviour of the corresponding components/devices in the test environment.

Each test case 180 embodies one test sequence of operations that the SUT is required to perform, and the test case 180 interacts with the SUT 30 via the interfaces that cross the test boundary.

There is one adaptor 184 for each interface between the SUT 30 and the environment (i.e. every interface that crosses the test boundary). In this example, each adapter 184 is a software module, but in other examples it can be a hardware module or a combination of both software and hardware. Each Adaptor 184 is arranged to communicate with the SUT 30 as instructed by the Test Case 180 in a manner indistinguishable from the CD Player, DVD Player, AudioVideo switch and Remote Controller. For example, Adapter 2 must interact with the SUT via the ICD interface in a manner indistinguishable from the real thing. These modules are specified using ASD.

The test router 182 is a software component specific to the SUT that routes the commands and data between the Test Case and the Adaptors. In one embodiment, the Test Router 182 is specified using ASD. In an alternative embodiment, the Test Router is generated automatically by the CTF.

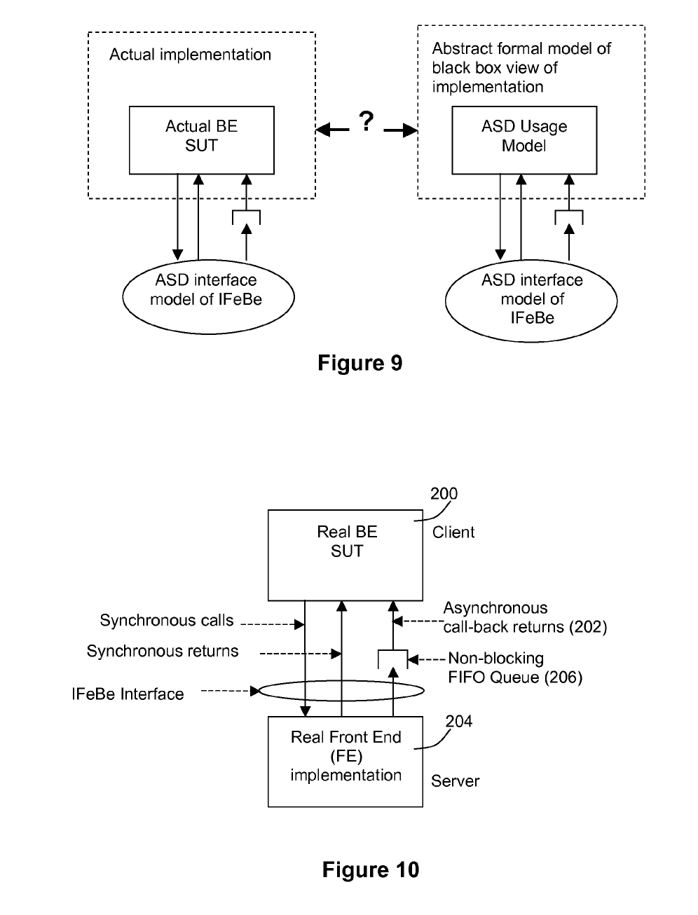

As shown with reference to step 132 of FIG. 6, the CTF creates a verified usage model of the SUT. However, before a usage model can be constructed, the test boundary must be defined. Furthermore, test sequences are generated and used to sample the behaviour of the SUT (by testing) to determine the probability of the SUT behaving in a manner sufficiently indistinguishable to the usage model according to a given statistical measure which may change depending on the importance of avoiding critical failure in the application of the control software (for example: to 99% confidence limits). FIG. 9 shows the test boundary surrounding the actual SUT versus the test boundary surrounding the usage model of the SUT. When defining the test boundary, the aim is to establish an equivalence, according to some statistical measure, between the usage model and the actual SUT.

For a given SUT, a test boundary is defined to be the boundary that encompasses the complete set of visible behaviour of the SUT and the boundary at which the test sequences are generated. A test and measurement boundary is defined to be the boundary at which the test sequences are executed and the results measured for compliance in the CTF testing environment. The test boundary defining the SUT must be the same as the test and measurement boundary in the testing environment.

Ensuring the test boundary of the SUT matches the test and measurement boundary of the testing environment may be possible in the case of fully synchronous behaviour between the SUT and its used interfaces. However, subtle complexities arise when dealing with communications from user interfaces to the SUT that are asynchronous, for example communications which are decoupled via a queue.

Asynchronous communications are common in client-server architecture, like the HES example described above, where signals are not governed by clock signals and instead occur in real-time. Client in this sense includes the device/system responsible for issuing instructions, and server is the device/system responsible for following the instructions, if appropriate. Inputs to the SUT may be held in a queue to be dealt with, as appropriate. In addition, the client may receive asynchronous responses from the server via a queue.

An illustration of the differences in test boundaries is shown in FIG. 10, which illustrates the client-server architecture where the client 200 receives asynchronous call-back responses 202 from the server 204 via a queue 206.

Front-end (Fe) and back-end (Be) are generalized terms that refer to the initial and the end stages of a process. The front-end is responsible for collecting input in various forms from the user and processing it to conform to a specification the back-end can use. The front-end is akin to an interface between the user and the back-end. In the client/server architecture the Fe is the client, and the Be is the SUT.

For the client-server architecture and the Be considered in this example, there are two distinct test boundaries. Therefore, there are two SUT definitions for the Be that could be chosen for the purposes of generating the test sequences and executing them within the test environment.

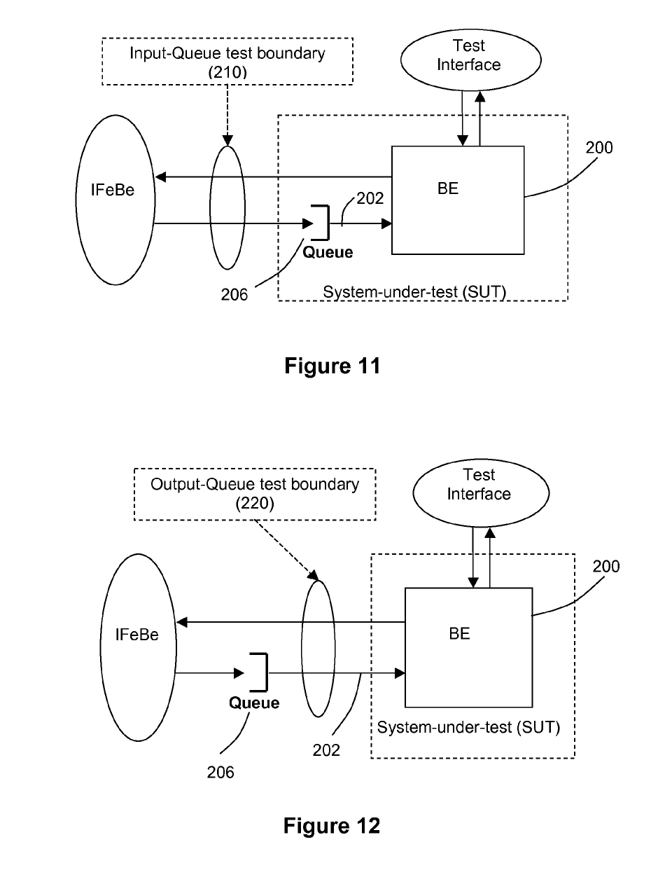

The different definitions are highlighted in FIGS. 11 and 12. FIG. 11 shows an “Input-Queue test boundary” 210. This test boundary is defined at the input side of the queue 206 that decouples the call-back responses 202 sent by the Fe (not shown in FIG. 11) to the Be 200. Therefore, the SUT being tested within the CTF comprises the Be component 200 and its queue 206.

FIG. 12 shows an “Output-Queue test boundary” 220. This test boundary is defined at the output side of the queue 206 that decouples the call-back responses 202 sent by the Fe (not shown in FIG. 12) to the Be 200. Therefore, the SUT being tested within the CTF comprises the Be component 200 only.

Due to the asynchronous behaviour introduced by the queue 206, the complete set of visible behaviour at the Input-Queue test boundary 210 is not necessarily the same as that at the Output-Queue test boundary 220. Sequences generated at the Output-Queue boundary 220 will contain events reflecting when call-backs are removed from the queue 206 whereas sequences observed at the Input-Queue boundary 210 will contain events reflecting when call-backs (to the SUT) are added to the queue 206. It is essential that the set of behaviour representing the population from which the test sequences are sampled and the boundary between the SUT and the test environment from which these test cases are executed and observed are the same. Thus, test sequences generated at the Output-Queue boundary 220 cannot be meaningfully executed and measured at the Input-Queue test boundary 210 in the testing environment.

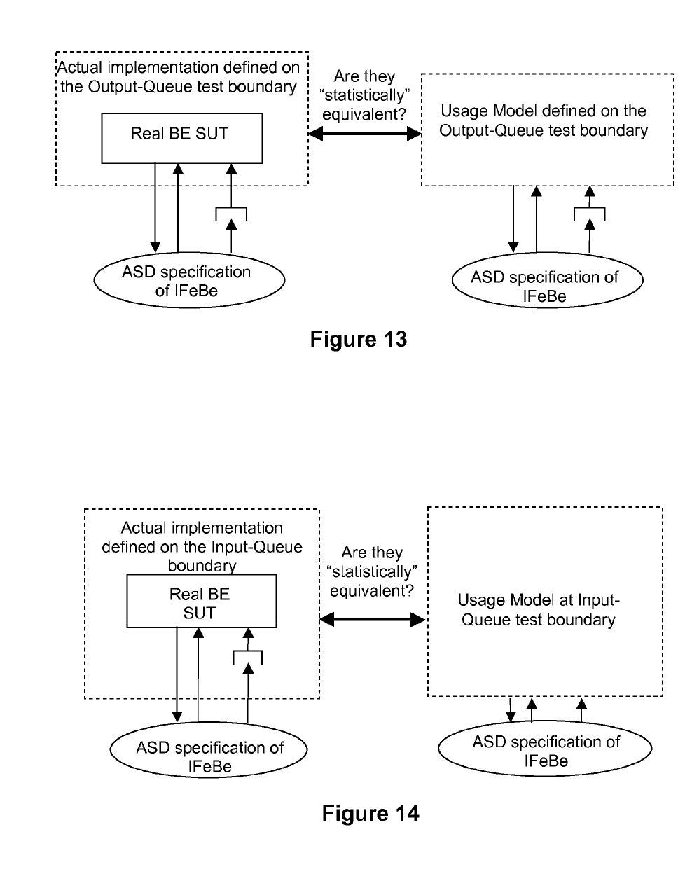

While in theory choosing either test boundary may pose no problems, in practice there is a trade off to be made. Choosing the SUT test boundary at the Output-Queue 220, as shown in FIG. 13, is beneficial from the point of view of specifying the corresponding usage model. This is because it is more intuitive and less complex since the effects and consequences of the queue 206 are outside the scope of the specification. In addition, more subtle behaviour, for example race conditions, can be targeted and tested with explicit test sequences. Furthermore, the usage model can be described directly within the SBS notation (as an extended version of an interface model) which in turn enables the application of the assignment of probabilities of different events, and generation of appropriate test cases. Further details regarding the assignment of probabilities to different events is discussed in more detail below, with reference to the extended SBS notation.

The requirement introduced in practice of using the Output-Queue test boundary 220 is that it might not be feasible in every case to connect the test environment and test execution to the output side of the queue 206. It is easier to access the interface before the queue than after it because the executable code running in the real environment will normally include both this queue behaviour and the internal thread that processes the queued events.

The alternative is to define the SUT on the Input-Queue test boundary, as shown in FIG. 14. However, this has two principle disadvantages in that it is frequently too complex to construct a usage model manually from the Input-Queue test boundary 210 and it would be infeasible to do so using the standard SBS approach known from ASD. In addition, there may be many sequences of behaviour observable at the Output-Queue test boundary 220 that are not distinguishable at the Input-Queue test boundary 210 because in it not possible at this boundary to observe when events are removed from the queue by the SUT.

For specification purposes, it is desirable to define the usage model at the Output-Queue Test Boundary 220. However, for implementation purposes, it is practical to connect the CTF test framework to the Input-Queue 210 boundary to drive the testing and observe the results.

In the solution of one embodiment of the present invention, the test and measurement boundary is defined at the Input-Queue test boundary 210, despite the fact that the SUT and therefore the usage model have been defined at the Output-Queue test boundary 220. Therefore, the CTF testing environment must reconcile this difference such that the compliance of every test sequence is determined as it would be at the Output-Queue test boundary 220, even though they are being executed at the Input-Queue test boundary 210.

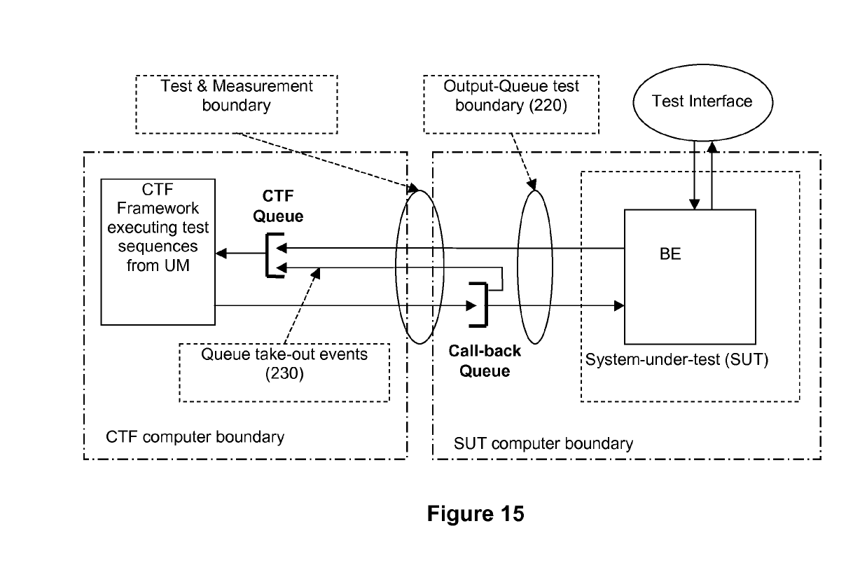

This is achieved by introducing a signal event 230. FIG. 15 shows the Input-Queue test boundary 210 extended with an additional stream of signal events 230 emitted when the SUT actually removes events from the queue 206. The generated test sequences will include these events so that the running test execution can synchronise itself with the SUT.

This part of the SUT, namely the queue 206 and the SUT's internal thread which removes events from the queue 206 and executes the corresponding actions must generate signals 230 in order to synchronise test case execution with the removal of events from the queue 206. These signals 230 are sent to the CTF framework 150 via interfaces provided by the framework for this purpose. As discussed above, in some cases part of the SUT may have been developed using ASD. In those cases, a software module, called ASD Runtime, may be replaced with a CTF software module in order to provide the necessary signals automatically as needed. Alternatively, in those cases where these parts of the SUT have been implemented through conventional software development methods instead of using ASD, the SUT must be modified, through introducing a dedicated software module, in order to ensure that the actual SUT implementation correctly generates these signal events 230.

The actual moment at which the signal event 230 is generated is the moment at runtime when the CTF “decides” to execute the rule corresponding to the event according to the execution semantics. This guarantees that the order in which the SUT removes call-back events from its queue and sends responses to the CTF test framework is preserved. These signal events 230 are not in the Usage Model; they are added automatically as test sequences are generated.

FIG. 15 shows the computer boundaries between the CTF test framework 150 and the SUT 30 during test execution. The Test and Measurement boundary is also the boundary between the two computers. In FIG. 15, an application programming interface (API) calls from the SUT to the CTF framework and the queue take-out signals are routed to the CTF test framework via the CTF queue, which serialises and preserves the order in which these calls and queue take-out signals occur. This is implemented such that the synchronous interface semantics are preserved so that there are no asynchronous behaviour or race conditions introduced by the CTF test framework that would not be present when the real front end is used instead.

As described above, the testing approach according to one embodiment of the present invention is based on the concept of Operational Usage Modelling. An Operational Usage Model is a rule from which all possible usage scenarios can be generated. For example, when a CD is playing it is possible to pause, stop, skip on or skip back.

A usage model is defined as the total set of observable behaviour required by every compliant SUT with respect to its interfaces. The usage model is verified by proving certain correctness properties using a model checker. Thereafter, test sequences are generated and used to sample the behaviour of the SUT (by testing) to determine the probability of the SUT behaving in a manner sufficiently indistinguishable to the usage model according to some statistical measure.

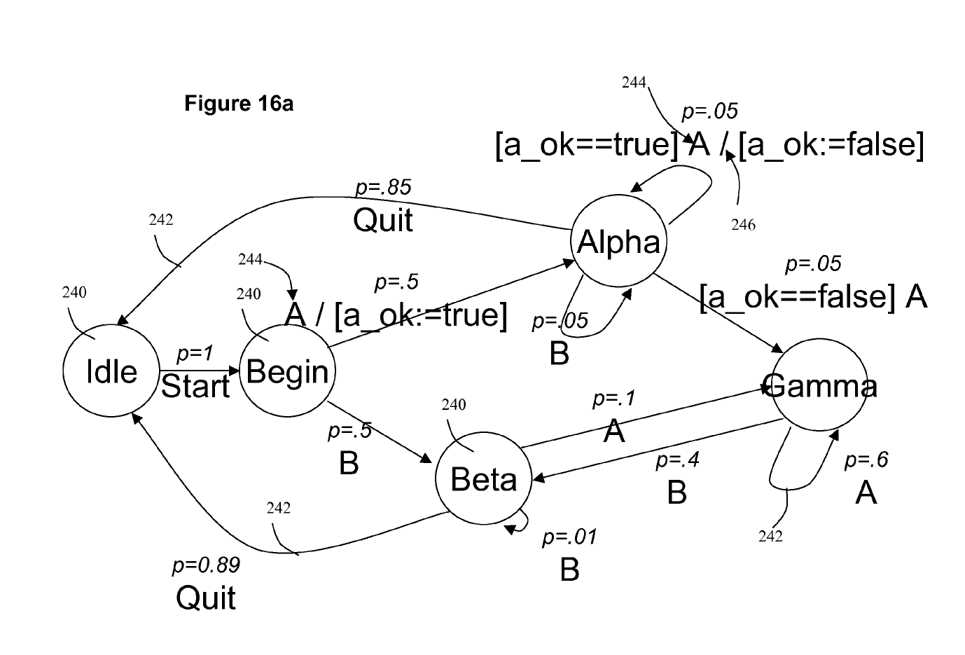

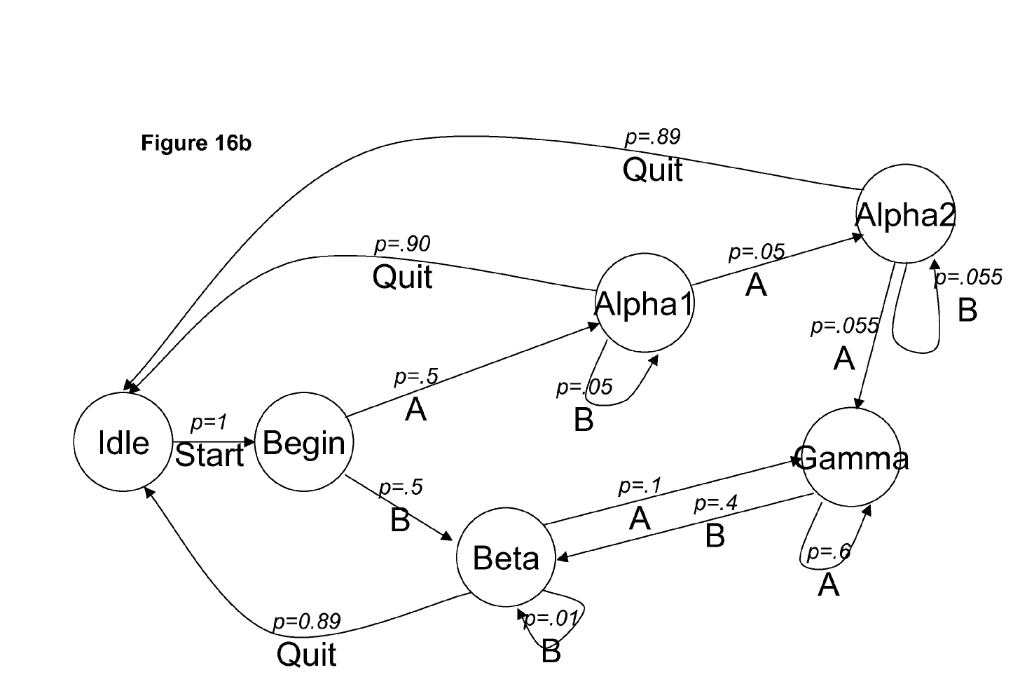

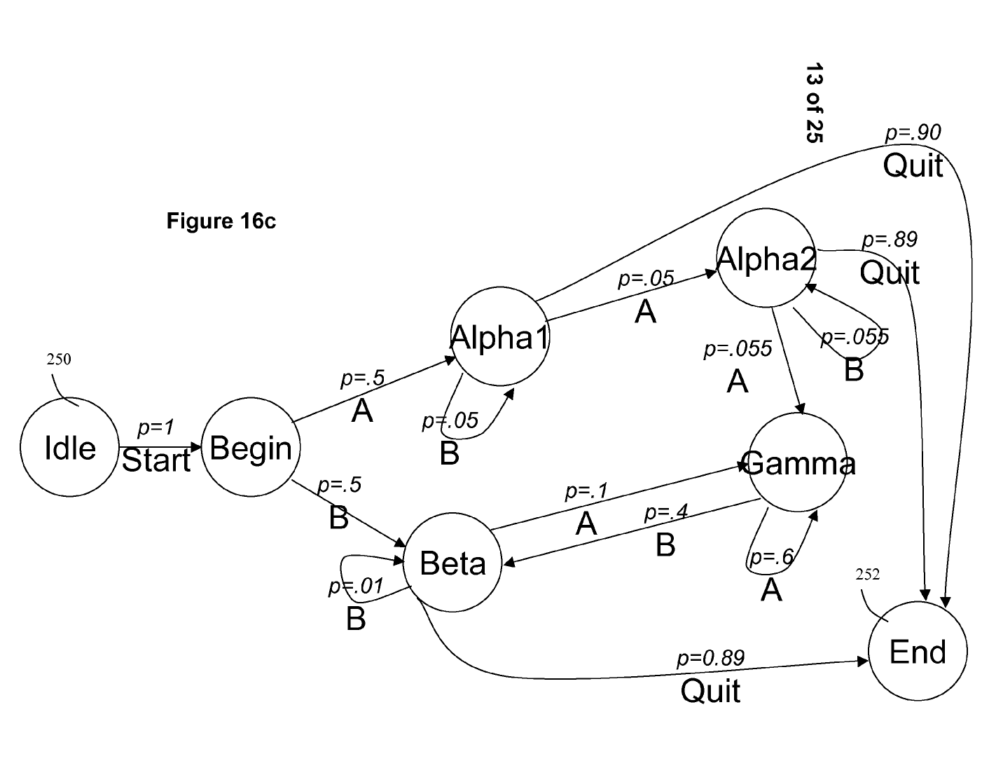

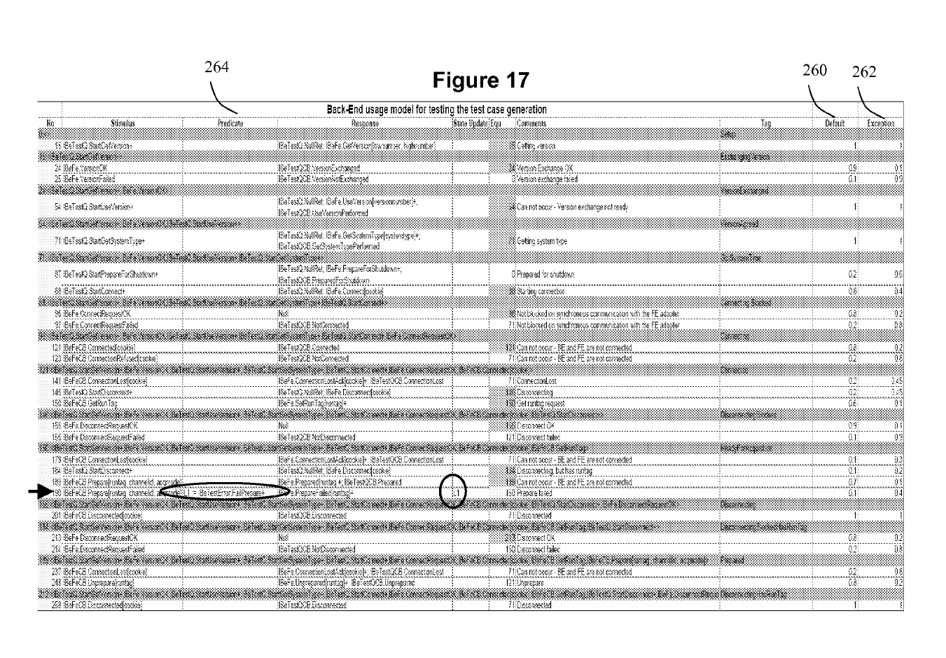

Graphically, an operational usage model is a state machine which comprises nodes and arcs. An example notation for a state machine is a mealy machine, as shown in FIG. 16a. The nodes 240 in FIG. 16a represent a current state, and the arcs 242 represent transitions from one state to another in response to possible input events which cause changes in or transition of usage state.

In one embodiment of the present invention, each arc 242 in the usage model is attributed with a probability factor regarding how likely that event (and as such that transition) is likely to occur. The probabilities are denoted by ‘p= . . . ’ and describe different usage environments, i.e. they define which of the possible events are expected to occur.

In another embodiment, every arc 242 from a state 240 is given an equal probability of occurring. For example, if a state has two arcs from it to two different states, then the probability of each arc is 50% i.e. p=0.5, and if there where three arcs, the probability of the event associated with each arc occurring is 33⅓%, i.e. p=0.333.

These models are built using an extended sequence-based specification (SBS) notation of the ASD tool chain as described in WO2005/106649. As such, the correctness and completeness of the models can be verified. The extended SBS notation is described in detail below. However, the extended SBS is based on the principles behind SBS notation which are well understood by persons skilled in the art.

In order to generate test cases automatically, the extended SBS models are translated into a different syntax. In one embodiment of the present invention, generation of the test sets is possible through the use of a tool called Java Usage Model Builder Library (JUMBL). JUMBL is a set of graphical user interface (GUI) tools and command lines for supplying automated, model based statistical testing. According to one embodiment of the present invention, the CTF utilises JUMBL in order to generate statistically meaningful testing results.

More information concerning JUMBL may be found in the user guide published by the Software Quality Research Laboratory on 28 Jul. 2003 and in the paper titled “JUMBL: A Tool for Model-Based Statistical Testing” by S. J. Prowell, as published by the IEEE in the Proceedings of the 36th Hawaii International Conference on System Sciences (HICSS'03).

In one embodiment, the input notation used for JUMBL is The Model Language (TML). TML is a “shorthand” notation for models, specifically intended for rapidly describing Markov chain usage models. Other embodiments could use other input notations, for example Model Markup Language (MML) and Extended Model Markup Language (EMML), for the input notation for JUMBL.

In the embodiment where TML is the input notation, it is necessary to translate the usage model (specified using the extended SBS notation) into a TML model. This is achieved in two stages: firstly all predicate expressions are expanded using an expansion process as described below. This process removes all predicate expressions and predicate update expressions and results in a Predicate Expanded Usage Model (PEUM). The second step is to convert the resulting Predicate Expanded Usage Model into a TML Model.

To simplify usage models, predicates are used to make the representations/models of system use more compact and usable. A predicate typically serves as a history of sequences that already have been seen, i.e. specifying the route through the state machine/usage model. In an alternative representation of a usage model, predicates can be removed and transformed into their equivalent states. However, this results in making the usage model unnecessary complex and large.

As above, in one embodiment, the input to JUMBL is a TML model, which is an equivalent state machine but without any state variables or predicates. The reason for this is that the statistical engine inside JUMBL uses a first order Markov model to compute all relevant statistics and therefore the input should contain no history information. As such, any models using predicates are not suitable for direct input into JUMBL. Thus, the usage models have to be transformed into their equivalent state machines where all state variables and predicates are removed. In practice, it is not feasible to achieve this transformation manually because it would take a disproportionate amount of time and is highly prone to errors.

FIG. 16a shows a mealy machine made from a Usage Model which includes predicates and probability information on each of the arcs 242. A mealy machine is a finite state machine that generates an output based on its current state and an input. Thus the state diagram will include both an input (I) 244 and output (O) event for each transition arc between nodes, written “I/O”. The nodes in the FIG. 16a represent states in the system being modelled, and the arcs represent transitions between states. However, to simplify FIGS. 16a and 16b, output events have been omitted.

An arc 242 that is labelled with a single event name “E” or “E/” symbolises the case where there is an input event E (i.e. ‘A’, ‘B’ ‘Quit’) which causes the transition between from a current state to a subsequent state, without causing a corresponding output event.

The notation [a_ok==true] is a boolean expression called a “predicate expression”. The notation [a_ok:=false] updates the value of the state variable (in this case) “a_ok” and is called a “predicate update expression”.

The notation P=0.05, [a_ok==true] A/[a_ok:=false] on one of the arcs coming out of state Alpha (and pointing back to State A) is has the following meaning:

In state Alpha, given input A, if the value of boolean variable a_ok is equal to true, then the system remains in state Alpha and the boolean variable a_ok is assigned the value false. There is an estimated probability of 0.05 that this will occur. In this example, there is no output shown; this is denoted by reference 246, in FIG. 16a, showing the omission of any output event after the ‘/’ symbol.

Similarly, the notation P=0.05, [a_ok==false] A has the following meaning:

In state Alpha, given input A, if the value of a_ok is equal to false, then the system transitions to state Gamma. There is an estimated probability of 0.05 that this will occur. Note that in this example, the value of a_ok is unchanged and again no output is shown.

Thus, the behaviour modelled in FIG. 11a is as follows: After the event “Start”, all “B” events that occur after the first “A” event but before the third “A” event are ignored. After the third “A” event, “A” and “B” events cause an oscillating transition between states Beta and Gamma until a “Quit” event occurs while in state Beta.

As above, the presence of predicate expressions and predicate update expressions has the effect that the resulting Usage Model in this form cannot be represented as a Markov model, as required by JUMBL. A Markov Model is a model of state behaviour that satisfies the Markov Property, namely that in any given present state, all future and past states are independent. In other words, the reaction to an event is determined only by the event and the state in which the event occurs; there is no concept of “history” or knowledge of what occurred previously. For example, an event E cannot be treated differently depending on the path taken through the Markov model to reach some state S in which the event E occurs, unless state S is only reachable through a single unique path. Both “predicate expressions” and “predicate update expressions” violate the Markov Property because “predicate update expressions” enable the history of the path taken to be retained, and “predicate expressions” enable a given event in a given state to be treated differently depending on the recorded history. Thus, in a Usage Model, the Markov Property does not hold.

The representation of the Usage Model input to JUMBL must be expressed in a form in which the Markov Property holds, for example using TML. In one embodiment of the present invention, the

Usage Model (SBS notation), which is represented by the Mealy Machine in FIG. 11a, is transformed by a process called Predicate Expansion to a Predicate Expanded Usage Model, as shown in FIG. 16b. All predicate expressions and predicate update expressions are removed from the Predicate Expanded Usage Model of FIG. 16b, by adding extra states and state transitions to the underlying model in such a way that the resulting Markov model has exactly the same behaviour as the original Usage Model but satisfies the Markov Property. Again, it is not feasible to achieve this transformation manually on an industrial scale because it would take a disproportionate amount of time and is highly prone to errors. According to one aspect of the this embodiment of the present invention, it is possible to convert usage models which do not satisfy the Markov Property (i.e. Mealy Machines) to those which do (i.e. Predicate Expanded Usage Models and TML models)

Every Usage Model (U) can be represented by a graph, where the nodes represent states and the edges represent state transitions. The edges are labelled with transition labels of the form (S,R) where S is the stimulus causing the transition and R is a sequence of zero or more responses. The complete set of behaviour described by U is thus the complete set of all possible sequences of transition labels corresponding to the set of all possible state transitions. Such a set of sequences of transition labels for U is called the traces of U and is written traces(U). Two Usage Models, U and V are defined to be equivalent if and only if traces(U)=traces(V).

For every Usage Model U for which the Markov property does not hold, there is an equivalent Usage Model Uₘ for which the Markov property does hold. Predicate expansion can be represented as a mathematical function P, such that Uₘ=P(U) and traces(Uₘ)=traces(U).

Mathematical function P may be implemented by automatically converting the unexpanded Usage Model U to a mathematical model in the process algebra CSP. A model checker (described in more detail later) is used to compute a mathematically equivalent labelled transition system (LTS) in which all predicate expressions and predicate update expressions are removed and ensures that the expanded usage model Uₘ satisfies the Markov property. In other words the LTS describes the behaviour of the expanded usage model Uₘ in which the Markov property holds and is equivalent to U. Therefore, the resulting Usage Model Uₘ is the Predicate Expanded equivalent of U.

A person skilled in the art will appreciate that other mathematical techniques, for example those based on graph theory could also be used to expand the usage model.

FIG. 16b shows the result of applying predicate expansion to the Usage Model shown in FIG. 16a.

After predicate expansion, the resulting Predicate Expanded Usage Model is translated to a TML model, for input to JUMBL. The syntax and semantics of TML are described in “JUMBL 4.5 User's Guide” published by Software Quality Research Laboratory on 28 Jul. 2003.

Other than the syntax, the principle difference between a Predicate Expanded Usage Model and a TML model concerns so-called “source” and “sink” states. A Usage Model represents the externally visible real-life behaviour of some real system made out of software, hardware or a combination of both. Since most industrial software systems cycle through their set of states, the set of all possible sequences for such a given system would typically be an infinite set of finite sequences, where each sequence represents an execution path of the system. In order to be able to generate finite test sequences, a sequence of behaviour must start at a recognisable “source” state and end at a recognisable “sink” state. TML models are required to have this property for all possible sequences of behaviour. However, Usage Models do not have this property and must therefore be transformed when converting them to TML Models.

A “source” state 250 is distinguished from all other states because there is only one source state per model, and that source state has only outgoing transitions and no incoming transitions. A “target” state 252 is distinguished from all other states because there is only one such state per model, and that target state has only incoming transitions and no outgoing transitions.

The TML generator creates an additional (sink) state named “End” and transforms all incoming transitions/arcs for the initial state (the source) into incoming transitions/arcs for the newly created sink state. This way the usage models can properly be checked using the model checker to ensure there are no so called “dead-end” situations. The model checker also checks that the generated TML model conforms to the requirements of JUMBL with respect to processing TML models as input. FIG. 16c shows the result of applying TML translation to the Predicate Expanded Usage Model shown in FIG. 16b.

Referring back to FIG. 16a, in one embodiment, the expected responses for each stimulus on each arc 242 are also specified. As described above, the CTF system enables the automatic generation of test cases. Specifying the expected responses in the models enables the generated test cases to be self validating. In other words, it is possible to determine from the results obtained through execution of the test cases whether the output results match the expected results, and as such whether the test result is a pass or fail. This output is recorded for later analysis.

The examples shown in FIGS. 16a to 16c are very simplified examples of the usage models (represented graphically), which are able to express the use of the system (and not the system itself). However, real software systems are much more complex and have a far greater number of states and arcs. As such, graphical models become too burdensome. As a result, it is typically to represent these usage models in tabular form, as shown in FIG. 17.

Typically SBS notation includes specifying stimulus, predicate, response, and output information.

A stimulus is an event resulting in information transfer from the outside the system boundary to the inside of the system boundary. An output is an externally observable event causing information transfer from inside to outside the system boundary. A response is defined as being the occurrence of one or more outputs as a result of a stimulus.

These concepts are well documented in the ASD system in WO2005/106649 (which is herein incorporated by reference) and are not discussed in further detail. A person skilled in the art will appreciate how SBS notation and Sequence Enumeration may be used to construct formal specifications of the interfaces of the SUT.

As mentioned above, the notation used for expressing usage modules is an extended version of the standard SBS notation. The extensions made to the standard Sequence-based Specification (SBS) notation as used in the ASD system to enable the modelling of Usage Models are described as follows. The extension is essential for allowing Usage Models to be specified while maintaining all the crucial advantages provided by the standard SBS notation as presented in the ASD system, namely accessibility in industry, completeness, and the ability to automatically prove correctness.

The extended SBS notation comprises one of more additional fields. In the example Usage Model extract of FIG. 17 there are four extension fields between the extended SBS Usage Model notation and the standard SBS.

Generally, at any given moment the SUT in an operational environment can receive one of many possible stimuli. The probability of one stimulus occurring as opposed to any of the other possible stimuli occurring is generally not uniform. So based on domain knowledge of the SUT, the usage modeller (test engineer) manually assigns a probability to each stimulus. In practice, most probabilities will be assumed to be uniform and the modeller will only assign specific probabilities where he judges this to be important. A single column of probabilities is called a scenario. Within a scenario, the probabilities are used to bias the selection of test sequences in each test case so that the distribution of stimuli in the test sequences matches the expected behaviour of an operational SUT. The probabilities of certain events occurring are not in themselves used to choose between scenarios; that is a choice made explicitly by the testers. When generating test sets of test sequences, the test engineer specifies which scenario should be used. Usually, different scenarios are defined to bias testing towards normal behaviour or exceptional behaviour. These would be devised based on application/domain knowledge of the usage modellers plus in some cases by measuring existing similar systems in operational use. For more information relating to devising usage models see the white paper titled “JUMBL: A Tool for Model-Based Statistical Testing” by S. J. Prowell, published Proceedings of the 36th Hawaii International Conference on System Sciences (HICSS'03) 0-7695-1874-5/03.

In one embodiment, the extended notation may include one or more probability columns. In the example shown in FIG. 17 there are two probability columns to the right of the “Tag” column, labelled ‘Default’ (260) and ‘Exception’ (262). The probability columns specify a complete set of probabilities and allow a single Usage Model to represent multiple Usage Scenarios. A Usage Model represents all possible uses of the SUT being modelled. A Usage Scenario represents all possible behaviours of the SUT within a specific operational environment or type of use. The column labelled “Default” (260) is the default usage Scenario; the column labelled “Exception” (262) represents the behaviour of the SUT when exceptional or what may be termed as “bad weather” behaviour is considered.

It is advantageous to be able to include different usage scenarios because although exceptional or “bad weather” behaviour may not occur frequently, as reflected in the low probabilities assigned to such “bad weather” behaviour in the “Default” or normal scenario, it may be extremely critical that the software functions correctly in the face of such infrequent “bad weather” conditions. For example, the emergency shutdown procedure of a nuclear reactor is (hopefully) very seldom if ever executed but in the event that operating conditions require an emergency shutdown, it is absolutely essential that it is performed correctly and so this infrequent behaviour should be tested extensively, and as such it is clearly desirable to ensure that that random test sets may exercise this behaviour extensively.

Allowing multiple Usage Scenarios enable a single Usage Model to be reused for a variety of different operating circumstances by generating differently biased random test sets and allows for the software reliability of different usage scenarios to be independently measured.

In one embodiment of the present invention, the “Predicate” column (264) is extended to contain label definitions in addition to the predicate expressions. An example of this expansion is shown in row 190 of FIG. 17 which has the label definition “L1:=IBeTestError.FailPrepare”. There is an action associated with each label definition and this is part of the mechanism for resolving non-determinism, as discussed in more detail below.

In another embodiment, the “State Update” column may also be extended to include label references, in addition to predicate update expressions. An example of this expansion is shown in row 190 of FIG. 17, which has the label “L1”. This is part of the mechanism for resolving non-determinism, see below. In this example, the label “L1” is both defined and referenced on the same row. This is coincidental. In many typical cases, the label will be referenced from a different row from that on which it is defined and may be referenced more than once.

A predefined stimulus ‘Ignore’ is defined which enables “allowed responses” to be identified in the Usage Model. The reason for enabling allowed responses is so that the generated test case programs are able to distinguish between responses of the SUT which must comply exactly with those specified in the Usage Model (called expected responses) from those which may or ignored (allowed responses).

An expected response is a response from the SUT that must occur as specified in the Usage Model. For example, a test sequence may be:

<StartMove, MovementStarted>

Here StartMove is the stimulus to the SUT and MovementStarted is the expected response. In one embodiment of the invention this sequence results in a generated test case like the following:

Call StartMove( ); //invoke SUT operation

AwaitResponse(MovementStarted); //synchronise on expected response

This is called an Expected Response Sequence because the response must occur in the specified place in the sequence. If the expected response is not received within a defined time-out because the SUT gives no response at all or gives some other non-allowed response the SUT is at fault and the test case fails.

As part of the expected behaviour of the SUT, other responses may be allowable, either instead of or in addition to the expected response. However, it is not expected that there will be an additional allowed response in every case. These responses are called “allowed responses” and the set of allowed responses might vary from state to state. The presence or absence of allowed responses has no bearing on whether or not the SUT behaviour is considered correct. A set of responses is designated as allowed responses by means of the Ignore stimulus. This definition has the scope of the Usage Model state in which the Ignore stimulus is specified. The presence of the Ignore stimulus in the extracted test sequence causes the Test Case Generator to add additional directives into the generated test case program enabling it to recognise and ignore the Allowed Responses.

As described above, the Usage Model represents the behaviour on all of the interfaces as seen from the viewpoint of the SUT. It is specified in the form of a Sequence-based Specification and each transition in the Sequence-based Specification, in one embodiment, contains one or more probabilities. These probabilities enable JUMBL to make appropriate choices when generating test sequences.

A problem arises when a non-deterministic choice arises out of design behaviour of the SUT, and it is possible to specify that a stimulus can result in two or more different responses. An example is shown in FIG. 13. A stimulus StartMove can result in two responses, i.e. MovementStarted (movement starts as intended) or MovementFailed (no movement due to an exceptional failure condition).

When generating a sequence to be tested, JUMBL can select one of these responses. However, it is not possible to predict which selection JUMBL will make in any given instance. As a result, when the corresponding generated test case is executed, the actual response chosen by JUMBL must be known in advance in order to determine whether the test has been successful.

Current industrial software testing practices commonly treat the SUT as a closed “black box”; that is, only the behaviour visible at the interfaces which cross the test boundary is accessible for testing. All internal behaviour of the SUT is both unknown and unknowable to the test engineer and the tests. When viewed as a black box, most software components display non-deterministic behaviour; that is, the component can generate more than one response for a given stimulus in a given state.

SUT State 0:

TABLE 1
Excerpt from a usage model, illustrating non-determinism

| Stimulus | Response | Next State |
|---|---|---|
| IFeBeCB.Prepare | ISpecAPI.ok | SUT State 1 |
| IFeBeCB.Prepare | ISpecAPI.fail | SUT State 2 |

Table 1 is one example of non-determinism called black box non-determinism and it is an unavoidable consequence of black box testing. This is the similar to the non-deterministic behaviour encountered in abstract ASD interface models. The means by which this choice is made is hidden behind the black box boundary and cannot be predicted or determined by an observer at that boundary. Therefore, it has not previously been possible to prove the correctness of a non-deterministic SUT by testing, irrespective of how many tests are executed.

All such black box testing approaches present the following problems: the interfaces of the SUT which cross the test boundary may not be sufficient for testing purposes. It is frequently the case that such interfaces designed to support the SUT in its operational context are insufficient for controlling the internal state and behaviour of the SUT and for retrieving data from the SUT about its state and behaviour, all of which is necessary for testing; and most systems exhibit non-deterministic behaviour when viewed as a black box. For example, a system may be commanded to operate a valve, and the system may carry out that task as instructed but there may be some exceptional failure condition that prevents the task being completed. Thus, the SUT has more than one possible response to a command and it cannot be predicted nor controlled by the test environment which of the possible responses should be expected and constitutes a successful test. It is for these and similar reasons that it is axiomatic in computer science that non-deterministic systems are untestable.

Within current industrial testing practice, this non-deterministic behaviour presents a problem when designing tests; it is not possible to predict which of the possible set of non-deterministic responses will be emitted by the SUT. Therefore, the test engineer using conventional software testing processes attempts to design tests which are able to cope with this uncertainty and still give reasonable results. This typically complicates test design and increases the difficulty of interpreting test results.

The testing approach employed, according to one embodiment of the present invention, also treats the SUT as a closed “black box” and within the statistical sequence-based approach used by the CTF, the non-deterministic nature of the SUT presents a similar problem in a form specific to the CTF, namely: when selecting a sequence, the sequence extractor (JUMBL) cannot predict which of the possible set of non-deterministic responses will be emitted at runtime by the SUT.

A solution to this problem provided by the present embodiment requires the black box boundary to be extended to include a test interface. The purpose of the test interface is to provide additional functions to enable the executing tests to resolve the black box non-determinism during testing by forcing the SUT to make its internal choices with a specific outcome. The usage model is annotated with additional information that enables the CTF to generate calls on the test interface at the appropriate time during testing.

This solution resolves the non-deterministic choice at runtime in the way that the sequence extractor assumed it would be resolved when selecting a test sequence. In the Usage Model, every state that allows the SUT to make a non-deterministic choice between responses and future system behaviour is identified as the Usage Model is constructed. A corresponding label (L1) is defined (in the predicate column 264 of FIG. 17) for each test case and is associated with an action to be executed by the SUT via the Test Interface, which is provided for this purpose, or by the test environment, at the time the generated test case testing this functionality is executed. For example, when the SUT is commanded to start movement, the Usage Model includes information regarding the non-deterministic response from the SUT. In other words, the usage model specifies what happens if the movement starts properly (the normal case) and what happens when it fails to move (the abnormal/exceptional case). The sequence extractor (JUMBL), when choosing a test sequence, may choose either the normal or abnormal case without being able to predict which case will occur at runtime, and so when selecting one or the other case specifies the response which is expected.

For states in the Usage Model where the SUT does decide how to resolve the non-deterministic choice, a label reference is given in the “State Update” column. This label reference, together with the definition of the associated action, is carried through into the TML Model and thus by the Sequence extractor into the extracted test sequence. The extracted test sequence thus contains within it the information as to which way the Sequence Extractor assumes the SUT will resolve the non-deterministic choice at runtime. This is not the same as predicate or history information and so the TML Model still satisfies the Markov Property.

When converting the test sequence to an executable test program in a suitable programming language such as C++ or C# or a suitable interpretable scripting language such as Perl or Python, the presence of the label informs the Test Case Generator to generate instructions in the Test Program to instruct the test environment or the SUT (via its test interface) to create, at runtime, the conditions that will force the SUT to resolve the non-deterministic choice according to the specification. The instructions to the SUT test interface or the test environment are generated from the action associated with the referenced label when it was defined in the Usage Model.

This advantageously provides a novel and unique solution to the problem of black box non-determinism, and in providing this solution, one aspect of the embodiment of the present invention permits non-deterministic SUTs to be tested using statistical methods.

A more detailed example of this solution is set out below. The test interface of the SUT provides the means of resolving this non-determinism at run-time. For example, the stimulus input may be a command to start movement, and the response (chosen by JUMBL) may be that movement failed to start. This is written in code notation as <stimulus, response>, i.e.:

<StartMove, FailToStartMovement>

The executable test case generated from this would be expressed in code notation as <ITEST call, stimulus,response>, i.e.:

<ITEST.FailMovement, StartMove, FailToStartMovement>

As a result, the SUT “knows” it is supposed to fail when it is requested to start a movement. The generated test case includes calls to the SUT Test Interface (the interface that communicates between the SUT and the CTF) in order to force the run-time behaviour of the SUT to match the sequence selected by JUMBL.

In an alternative example, if JUMBL chose the sequence: <StartMove, MovementStarted>, the executable test case generated from this does not need to have an <ITEST.AllowMovement> in its sequence since this additional stimulus on the Test Interface is only required for exceptional behaviour. If omitted the SUT is assumed to behave ‘normally’ and successfully complete the request.

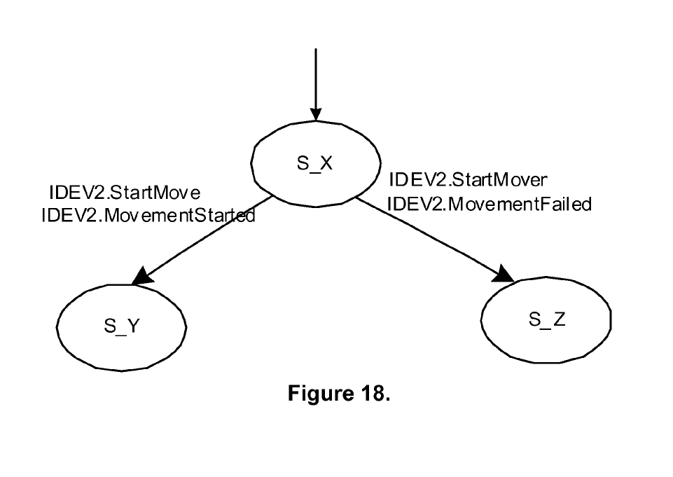

FIG. 18 represents the presented behaviour, and Table2 reflects the solution:

TABLE 2
Excerpt from a usage model

| | | | | |
|---|---|---|---|---|
| | | | State | Next |
| Stimuli | Predicate and Labels | Response | Update | State |

State S_X

| | | | | |
|---|---|---|---|---|
| IDEV2.StartMovement | | IDEV2.MovementStarted | | S_Y |
| IDEV2.StartMovement | T_N := ITEST.FailMovement | IDEV2.MovementFailed | T_N | S_Z |

If the SUT can succeed or fail a particular request, only the exception situation will be preceded by a request on the Test Interface. If not preceded by a test interface call, the SUT is assumed to succeed the request.

The second cause of non-determinism is the introduction of the call-back queue, as described with reference to FIG. 15 above, for enabling asynchronous call-back events from the Front End component to the Back End component. When the test boundary at which the usage model is specified is defined to be the Output-Queue test boundary, then this form of non-determinism is eliminated. This is because the communication between the test environment and the SUT is synchronised by means of the signal events sent when call-back events are removed from the queue. When the test boundary is specified at the Input-Queue boundary, then this form of non-determinism is handled by a tree walker component (described in detail later) that “walks a tree” defining all possible valid sequences of behaviour allowed by a compliant SUT according to the interfaces it is using.

The third cause of non-determinism is due to the user interface IFeBe allowing some freedom for the Be component to choose the order in which it sends some events to Fe. Therefore, the ordering of events may be non-deterministic from the testing environment's point of view. This type of non-determinism is a property of the IFeBe interface and is independent of the test boundary at which the usage model is defined. In one embodiment of the present invention, test execution is monitored by the tree walker component.

The fourth cause of non-determinism arises when the SUT is allowed to choose whether or not some events are sent at all. This form of non-determinism is a property of the IFeBe interface and is independent of the test boundary at which the usage model is defined. The solution to this type of non determinism is achieved through an extension of the concept of Ignorable Events and in one embodiment of the present invention, this is through use of a mechanism called “Ignore Sets”, as described in greater detail below.

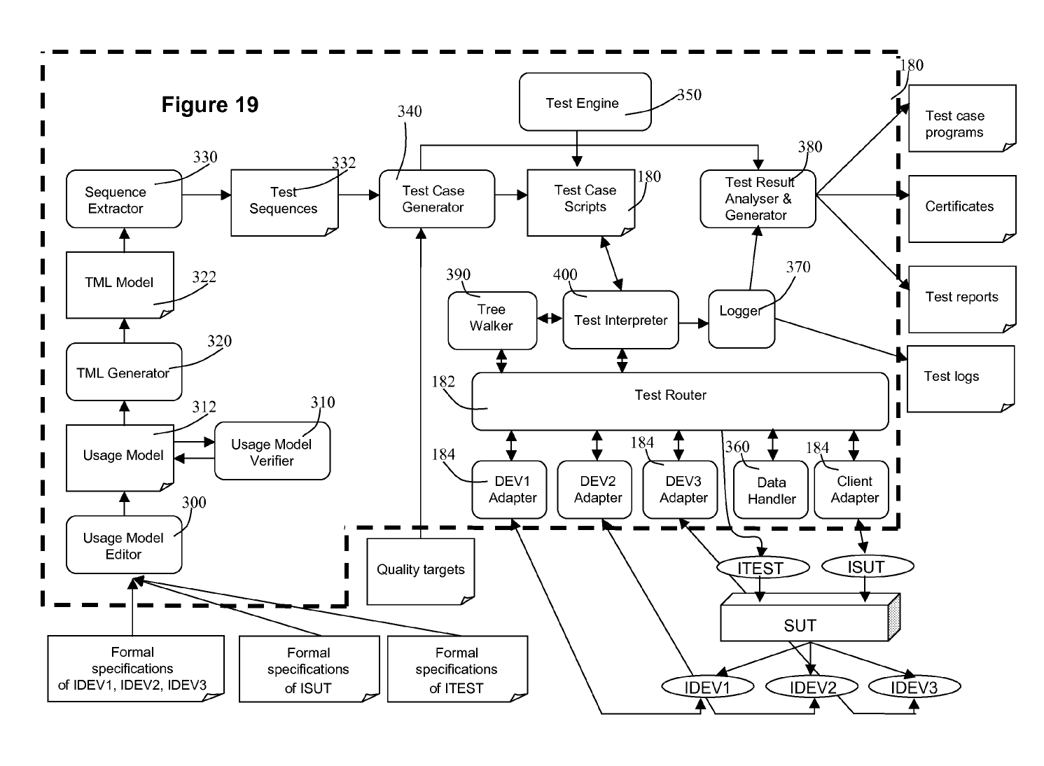

FIG. 19 is a functional block diagram of the CTF 150, showing in detail the functional components of one embodiment of the present invention. The dashed line in FIG. 19 denotes the components which make up the CTF, and the external components which interact with the CTF, including: the inputs to the CTF, the outputs from the CTF, and the SUT 30.

As shown, the CTF 150 comprises: a usage model editor 300, and a usage model verifier 310, for creating and verifying a correct usage model 312 in extended SBS notation; a TML Generator 320, for converting the Usage Model 312 into a TML model 322; a sequence extractor 330, for selecting a set of test sequences 332 from those specified by the usage model 312; a test case generator 340, for translating the test sequences 332 into test case programs 180; and a test engine 350 for automatically executing the test case programs 180.

The CTF also comprises: a data handler 360 for providing the test case programs 180 with valid and invalid data sets, as well as validate functions to check data; a logger 370 for logging data such that statistics may be calculated; a test result analyser and generator 380, for determining whether tests are passed or failed, and for generating reports regarding the same; a tree walker 390, for tree walking automaton by walking through every valid sequence of behaviour allowed by a compliant SUT according to the interfaces it is using; and a test interpreter 400, for monitoring the events occurring in connection with the tree walking automaton.

The CTF further comprises a test router 182, for routing calls from the test cases to the correct interfaces of the SUT and vice versa; and a plurality of adapters 184 for each device/client interface, for implementing the corresponding interface. The interaction of the CTF with the SUT is shown in FIG. 19 in relation to the interconnection of components. A more detailed illustration of the interaction is shown in FIG. 8.

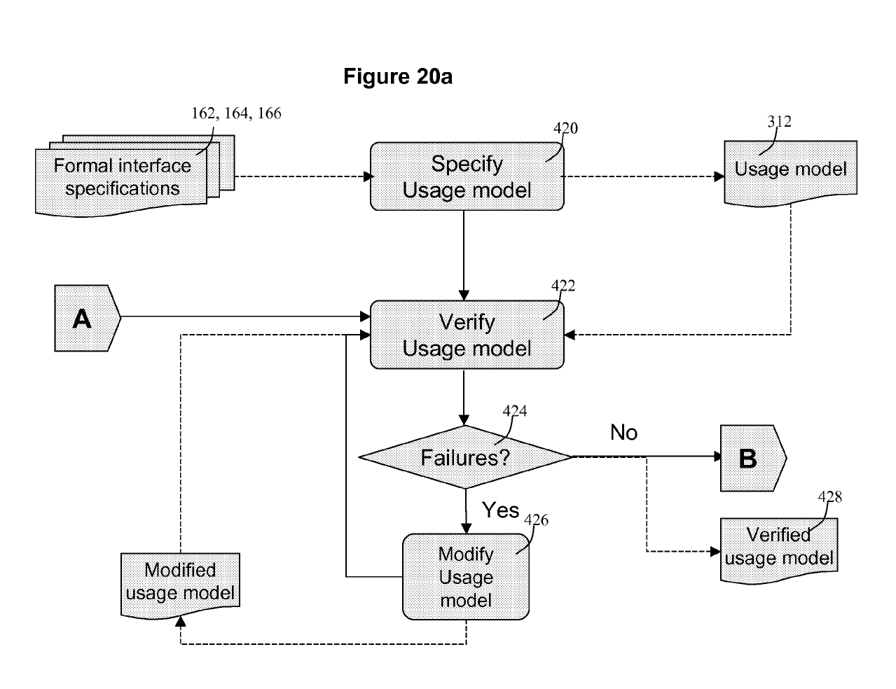

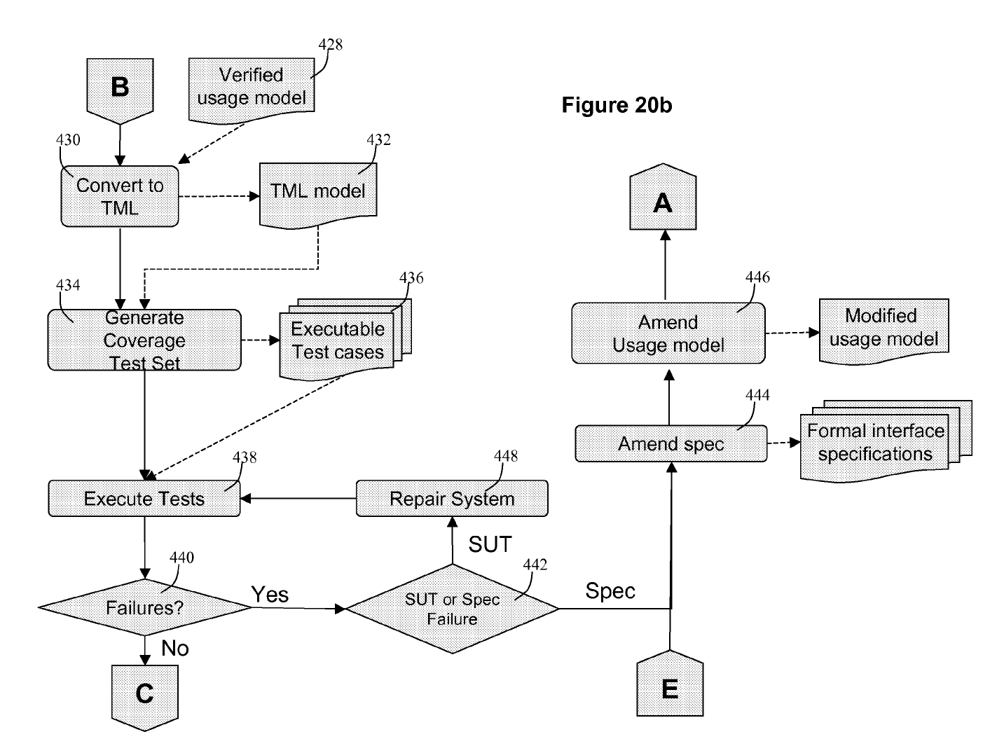

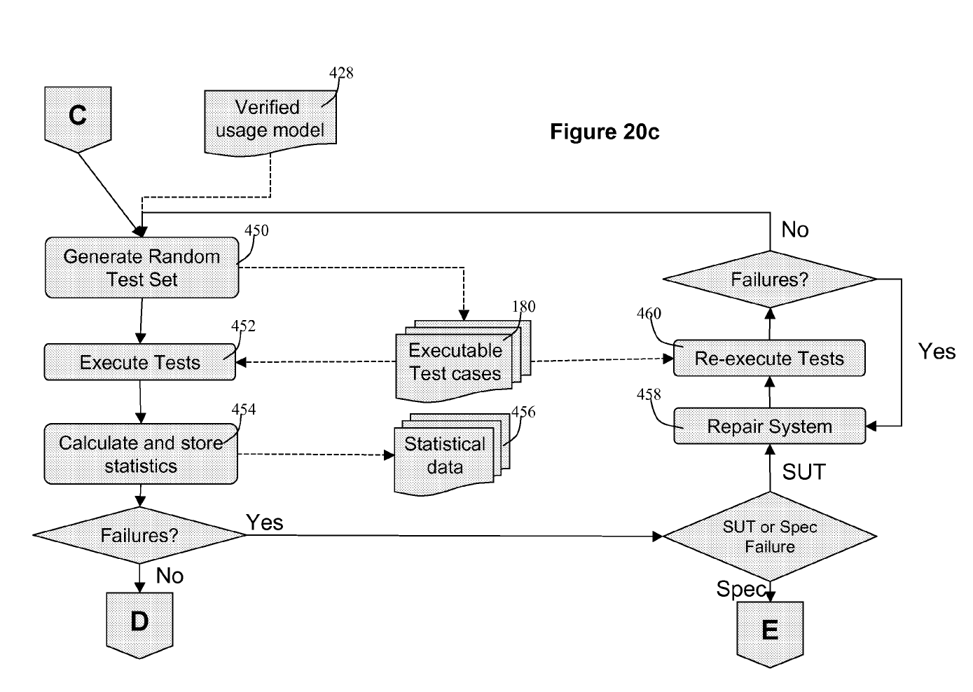

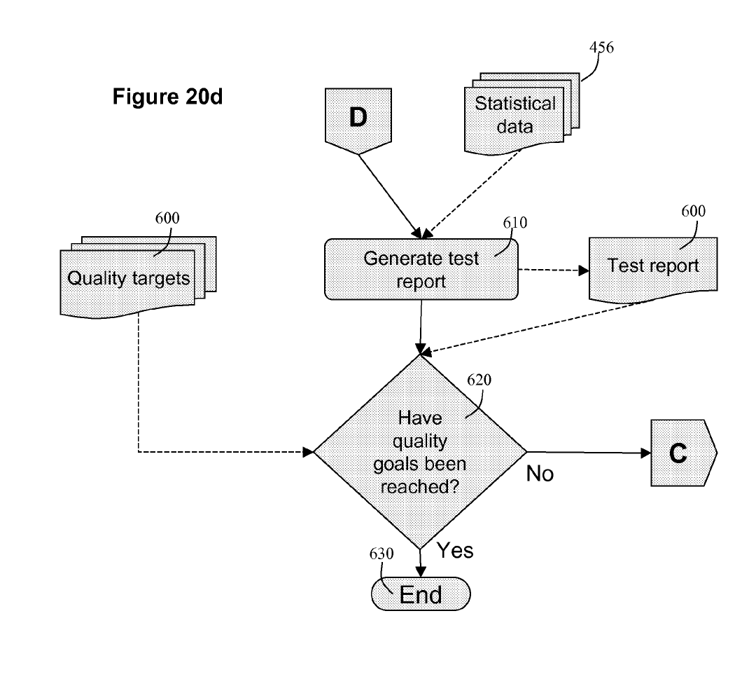

The method of one embodiment of the present invention will now be explained in more detail with reference to FIG. 20a through 20d.

The Usage Model Editor is a computer program which provides a graphical user interface (GUI) through which an expert Test Engineer constructs and edits a Usage Model that describes the combined use of all component interfaces and test interface, together with labels to resolve non- determinism within the SUT. An expert Test Engineer in this context is a person who is skilled in software engineering and software testing and who has been trained in the construction of Usage Models. An expert Test Engineer is not expected to be skilled in the theory or practice of mathematically verifying software. An important advantage of the CTF is that advanced mathematical verification techniques are made available to software engineers and others who are not skilled in the use of these techniques.

FIG. 20a shows how a Usage Model is verified and results in a Verified Usage Model which is the basis for the remainder of the process.

An expert Test Engineer analyses the formal Interface Specifications 162, 164, 166 and specifies the behaviour of the SUT, as it is visible from these interfaces and in terms of interactions (control events and data flow) to and from the SUT via these interfaces. The expert human Test Engineer specifies, at step 420, the usage model 312 using Usage Model Editor 300 in the form of an SBS, as described in WO2005/106649, and further extends this to include one or more probability columns, label definitions in the predicate column and label references in the state update column.

The Usage Model Verifier 310 is the component that mathematically verifies a given Usage Model for correctness and completeness with respect to the agreed interfaces.

The Usage Model is verified, at step 422, by automatically generating a corresponding mathematical model (for example by using the process algebra CSP), from the Usage Model 312 and each Formal Interface Specification 162, 164, 166 and mathematically verifying automatically whether or not the Usage Model 312 is both complete and correct. The exact form of the process algebra is not essential to the invention. It is to be appreciated that a person skilled in the art may identify another process algebra suitable for this task. The present inventors have knowledge of CSP, which is a well known algebra. However, software engineers familiar with a different process algebra, for example, one that has been specifically developed for another function, or which has been modified, will immediately understand that those process algebras could also be used.

As described in detail below, a Usage Model is complete if every possible sequence of behaviour defined by the Formal Interface Specifications is a sequence of behaviour defined in the Usage Model. A Usage Model is correct if every possible sequence of behaviour defined in the usage Model is a correct sequence of behaviour defined by the Formal Interface Specifications.

The model verifier 310 is arranged to detect, at step 424, if there are any errors, and if errors are detected in the Usage Model, the Usage Model is corrected by hand, at step 426, and step 422 is repeated. If no errors are detected, the Usage Model is designated as the Verified Usage Model 428 and the next process is to convert the Usage Model (in extended SBS notification) to a TML model by the TML generator, to generate test cases.

The correctness of a usage model must be established before test sequences can be generated in a statistically meaningful way. The correctness property is established in two stages. In a first stage, there is a set of rules called “well-formedness rules” to which the usage models must adhere. In one embodiment, the model builder (the usage model editor) will enforce them interactively as users (test engineers) construct the models using SBS. In a second stage, the usage model, when converted to the mathematical model, must satisfy a set of correctness properties that are verified using a model checker. In one embodiment the model checker is an Failures-Divergence Refinement (FDR) model checker or model refiner.

The well-formedness rules define when a usage model is correct and complete (i.e. well-formed). A usage model is well-formed when:
1. Every Canonical State is complete;
2. Every spontaneous unsolicited response is ignorable;
3. All other response events are solicited, expected responses to stimuli from the test environment (i.e. IFeBe for example). If necessary, the test interfaces is used to make it so;
4. All specified black box non-determinism is resolved using labels and the test interface; and
5. Ignorable events are never in the test sequence as being required. An event identified as ignorable by an Ignore Set in a canonical state cannot also appear as a response on any rule within that same state.

For a given Usage Model, there are three properties to be established using formal verification. Firstly, the usage model is checked to ensure compliance with respect to its interfaces. Secondly, the usage model is checked to ensure it is valid with respect to its interfaces. And, finally, the usage model is checked for completeness with respect to its interfaces.

When the usage model is found to be compliant, valid and complete, the total set of test sequences from which test sets are drawn is complete and every test sequence drawn from that set is a valid test that will not result in a false negative from a compliant SUT.

An explanation of how each of the three properties is considered in order to establish the compliance, validity and completeness of a single SUT interface is described below. A person skilled in the art will appreciate that the following definitions and equations may be extended for multiple interfaces and ignorable events.

Let:

UM=Complete (legal and illegal behaviour) usage model being verified, with all CBs (call-back events) renamed to MQout.CB.

UM_{L}=Legal behaviour of UM only.

UI=Complete (legal and illegal behaviour) set of used interfaces interleaved with one another. For example, if there were two interfaces called IFeBe and IIPBe, then UI would be defined as IFeBe |∥ IIPBe, where the notation |∥ represents the parallel interleaving of processes.

UI_{L}=Legal behaviour of UsedInterfaces only.

IFeBe=Complete (legal and illegal) for the FeBe interface against which UM is being verified, with all CBs (call-back events) renamed to MQin.CB.

IFeBe_{L}=Legal behaviour of IFeBe only.

IIpBe=Complete (legal and illegal) for the IpBe interface against which UM is being verified, with all CBs (call-back events) renamed to MQin.CB.

IIpBe_{L}=Legal behaviour of IIpBe only.

A Usage Model UM is compliant with respect to a set of used interfaces UI precisely when:
1. A complete UM and a complete UI decoupled by a queue do not invoke illegal behaviour;
2. UM and UI decoupled by a queue do not deadlock each other; and
3. UM and UI decoupled by a queue do not livelock when all communications other than the set of events shared by UM and UI are hidden.

A UM is valid with respect to a set of used interfaces UI precisely when UM is compliant with respect to UI and all traces in UM_{L} are allowed by the used interfaces UI decoupled by the queue. This guarantees that every test sequence generated from UM_{L} represents behaviour required by a compliant SUT and avoids invalid test cases.

A usage model UM is complete with respect to a set of used interfaces UI precisely when UM is compliant with respect to UI and is able to handle all legal behaviour specified by UI.

This does not imply that all traces in UM are also traces of UI or that the UM will generate all test sequences that are available from the viewpoint of UI, due to the asynchronous behaviour introduced by the queue.

A person skilled in the art will appreciate how to implement any of the above completeness, validity and compliance checks in accordance with the process algebra being used, for example CSP

Some events in the IFeBe interface represent behaviour optional to a compliant SUT; that is, the SUT is not obliged to send such events but if it does so, it must do so only when the state of the IFeBe allows them. As above, these events are called ignorable events.

An ignorable event is an event sent from the SUT to some used interface, UI, such that: whenever the UI allows the event, a compliant SUT can chose whether or not to send it; and whenever the UI does not allow the event, if the SUT sends it then the SUT is not compliant.

The CTF handles ignorable events as follows:
1. Ignorable events must not appear as required behaviour in any test sequence.
2. The UI specification determines when ignorable events can be sent by a compliant SUT.
3. A SUT sending such an event when it is not permitted by the UI is noncompliant.
4. A SUT that never sends such an event at all is compliant (or rather not noncompliant).
5. Whenever an ignorable event is observed during test execution, if the event is not allowed by the current state of the corresponding interface, the test fails and the SUT is not compliant.
6. Whenever such an event is observed during test execution and it is allowed by the current state of the corresponding interface, it is ignored and the test continues.
7. An event is ignorable if and only if it is a member of an Ignore Set defined as such by a special directive in the UM. The scope of this directive is the canonical state in which it appears.

According to one embodiment of the present invention, Ignore Sets are used to identify events as being ignorable with the current canonical state, and to specify when a test sequence is supposed to accept and ignore the ignorable events. Ignore sets are specified by special rules in the usage model. In one embodiment, each canonical state has an “ignore” directive which is followed by a list of events that are ignorable. This information is carried through the CTF framework and results in labels within the tree being walked during test execution (i.e. during tree walking automaton). The labels in the tree enable the tree walker component to know from any given state whether an event is ignorable or not.

References above to a tree walking automaton relate to the tree walker 390 in FIG. 19. A tree walking automaton (TWA) is a type of finite automaton that follows a tree structure by walking through a tree in a sequential manner. The “tree” in this sense is a specific form of a graph, which is directed and acyclic. The top of the tree is a single node describing the events that are allowed and identifying the successor node for each such event. By examining the events sent between the CTF framework and the SUT at runtime, the tree walker follows a path through the tree representing the sequence of observed events as they unfold. After each event has occurred, the tree walker advances to the successor node corresponding to the event observed. This successor node then defines the complete set of events that are allowed if the SUT is demonstrating compliant behaviour. If any other event is observed, then the SUT is not compliant. The compliance of the SUT is judged based on the tree that is constructed to represent all possible compliant behaviour, instead of judging the compliance of the SUT against the specific test sequence being followed. As such, it is possible to identify observed sequences of behaviour that, although possibly different to the test sequence, are nevertheless valid non-deterministic variations of the test sequence being executed. This is how the third cause of non-determinism above is addressed.

In other words, the purpose of the tree walking automaton (TWA) is to verify at runtime that every event exchanged between the test environment and the SUT is valid. The TWA enables the test interpreter to distinguish between ignorable events arriving at allowable moments and can therefore be discarded and those that are sent by the SUT when they are not allowed according to the IFeBe and thus represent noncompliant behaviour. In addition the TWA enables the test interpreter to distinguish between responses that have arrived allowably out of order and those representing noncompliant SUT behaviour.

The TWA monitors all communication between the test framework and the SUT and walks through a tree following the path corresponding to the observed events. Each node in the tree is annotated with only those events that are allowed at that point in the path being followed. Therefore illegal events representing noncompliant SUT behaviour are immediately recognised and the test terminates in failure.

A set of ignorable events is defined for a specific canonical equivalence class in the usage model. Annotations in the graph enable these ignorable events to be distinguished from other events. The graph determines when these events are allowed; the annotation enables them to be discarded. In particular, it enables the interpreter to distinguish between allowed events that have arrived too early and those to be ignored. By labelling each ignorable event in the tree using information from the “ignore sets” in the usage, enables such events to be omitted from test sequences. Nevertheless such events are validated to ensure that if they occur during a test run, they do so at allowable moments. This is how the fourth cause of non-determinism above is addressed.

The tree traversed by the TWA is generated automatically from the usage model after it has been formally verified. It is generated from a labelled transition system (LTS) corresponding to a normalised, predicate expanded form of the usage model and includes the call-back queue take-out events. The paths through the resulting tree describe every possible legal sequence of communication between the SUT and its environment.

When a test sequence starts, the tree is loaded, an empty pending buffer is created and the tree walking automaton waits at its root for the initial event in the test sequence. At each step in the test sequence, the current event being processed is either a response from the test environment to the SUT or an expected stimulus sent by the SUT to the test environment. In the former case, the test interpreter sends the response event to the SUT via the SUT's queue, the graph walking automaton moves to the next corresponding state in the graph and all instances of events pending in the buffer that are defined as ignorable in the new node of the graph are removed from the buffer.

In the latter case, a test interpreter 400 is waiting for the test environment to receive the current event in the test sequence from the SUT. The first step performed by the test interpreter is to check whether the expected event has already been sent by the SUT too early and is therefore being buffered. If so, then this event is removed from the buffer, the tree walking automaton moves to the next corresponding state in the tree and all instances of events pending in the buffer that are defined as ignorable in the new node of the tree are removed from the buffer. If the expected event is not being buffered, then precisely one of the following cases will arise:
1. A timeout occurs within the test environment, signalling the fact that no event was sent by the SUT within an expected timeframe and therefore the test case has failed.
2. The test interpreter receives the expected event in the test sequence from the SUT. The tree walking automaton moves to the next corresponding state in the tree, all instances of events pending in the buffer that are defined as ignorable in the new node of the tree are removed from the buffer and the test interpreter moves to the next event in the test sequence.
3. The test interpreter receives an unexpected event from the SUT that is defined as allowed. This is viewed as a possible legal re-ordering of events and therefore the event is placed into the pending buffer. The tree walking automaton moves to the next corresponding state in the tree, all instances of events pending in the buffer that are defined as ignorable in the new node of the tree are removed from the buffer and the test interpreter moves to the next event in the test sequence.
4. The test interpreter receives an unexpected event from the SUT that is defined as illegal. In this case, the test terminates in failure. This prompt test failure notification means that noncompliant behaviour will be recognised by the first event that deviates from the allowed path of behaviour.
5. The test interpreter receives an unexpected event from the SUT that is defined by the current state in the tree as ignorable. In this case, the test interpreter will discard the event received by the SUT and remain at the same point in the test sequence.

A test case terminates successfully precisely when the test interpreter has reached the end of the test sequence without a failure being identified and with the pending buffer being empty.

FIG. 20b shows how a set of executable test cases are generated for use in performing the coverage testing of steps 104 to 108 of FIG. 7.

The TML Generator automatically translates, at step 430, the verified usage model 428 into a TML model 432 as described above in relation to usage models and predicate expansion.

The TML model 432 produced by the TML Generator 320 is input to the Sequence Extractor 330, which uses statistical principles to select a set of test cases (test sequences in the stimuli/response format) from those specified by the Usage Model/TML Model. In one embodiment the Sequence Extractor 330 is the existing technology ‘JUMBL’. The Sequence Extractor 330 is arranged to generate the coverage test set and random test set described above. The Sequence Extractor may also be arranged to generate Weighted Test sets, which are a selected set of sequences in order of ‘importance’, which implies that those paths through the Usage Model that have the highest probability are selected first. The generated set of test sequences will therefore have a descending probability of occurrence. In other words, the test set will contain the most likely scenarios.

When the Verified Usage Model is automatically converted, at step 430, to a TML Model, the Sequence Extractor the selects, at step 434, a minimal set of test sequences which cause the executable test cases to visit every node and execute every transition of the Usage Model. As described above, one embodiment of the Sequence Extractor is JUMBL which uses graph theory for extracting this set of test sequences. A person skilled in the art, familiar with graph theory, will appreciate other approaches can be used.

The Test Case Generator 340 converts this set of Test Sequences into a set of executable Test Cases 436 in a programming language such as C++ or C# or an interpretable scripting language such as Perl or Python. Where necessary, a standard software development environment such as Visual Studio from Microsoft is used to compile the test programs into executable binary form. The result is called the Coverage Test Set.

All tests in the Coverage Test Set are executed, at step 438. However, no statistical data is retained from the execution of these tests because the coverage test set do not test functionality of the SUT sufficiently to result in statistically meaningful results.

The set of successfully executed Coverage Tests may be reused after each subsequent modification to the SUT.

The results of executing the coverage test set are analysed, at step 440. If none of the test cases in the coverage test sets fail, the process continues with the Random Testing as shown in FIG. 20c at point C.

However, if one or more Coverage Tests fail, either the Formal Specifications are incorrect, or the SUT is wrong. Test engineers can determine, at step 442, on the basis of the test case failures whether the SUT behaviour is correct but one or more of the formal specifications is wrong. In this case, both the Formal Specifications and the Usage Model are amended as necessary, in steps 444 and 446, to conform to actual SUT behaviour and the usage model is verified again at step 422 (through point A in FIG. 20a).

Alternatively, after reviewing the test case failures, it may be determined by expert assessment that the SUT behaviour is incorrect and the SUT must be corrected before Random Testing can begin. In this case, the SUT is repaired, at step 448, and testing continues at step 438.

When all coverage tests are successfully executed by the SUT, the SUT is deemed “ready for random testing” and of sufficient quality to make the reliability measurement meaningful; the process continues as per FIG. 20c at point C. When all Coverage Tests are passed, the SUT is deemed to be of sufficient quality for reliability measurements to be meaningful.

FIG. 20c shows steps relating to Random Testing (Step 112 in FIG. 7) in which a sufficiently large set of test cases is randomly generated, at step 450, and executed, at step 452, in order to measure the reliability of the SUT. The size of the test set is determined as a function of a specified Confidence Level, and part of ‘Quality Targets’ which are specified for the SUT. Quality Targets information is a specification of the required Confidence Level and Software Reliability Levels and captures the principle “stopping” criteria for testing. The Quality Targets information is recorded within the CTF database. The Confidence Level also determines the number of test cases required by the test case generator, as described further below.

The Sequence Extractor extracts the sufficiently large set of sequences at random from the TML model generated automatically from the Usage Model, weighted according to the probabilities given in the specified usage Scenario.

The Test Case Generator converts this set of Test Sequences into a set of executable Test Cases in a programming language such as C++ or C# or an interpretable scripting language such as Perl or Python. Where necessary, a standard software development environment such as Visual Studio from Microsoft is used to compile the test programs into executable binary form. The result is called a Random Test Set.

The tests are executed, at step 452, and the results are retained, at step 454, and added to the SUT associated statistical data 456 used for measuring software reliability. If all tests have passed, the process continues at point D in FIG. 20d and measured reliability and confidence levels are compared against quality targets. If one or more tests fail, either the formal specifications are incorrect, or the SUT is wrong.

Again, test engineers can determine from the test case failures whether the SUT behaviour is correct but one or more of the formal specifications is wrong. In this case, both the Formal Specifications and the Usage Model are amended as necessary, in steps 444 and 466, to conform to actual SUT behaviour and the usage model is verified again at step 422 (through point E in FIG. 20b).

Alternatively, after reviewing the test case failures, it may be determined by expert assessment that the SUT behaviour is incorrect and the SUT must be corrected before Random Testing can continue. In this case, the SUT is repaired, at step 458, and testing continues at step 460. After each repair cycle, the failed test set is re-executed as a regression test to ensure the reported failures are properly repaired. In addition, any or all of the previous executed random test sets and/or the coverage test set might be re-executed as regression tests before continuing with random testing. During this regression testing cycle, statistical data is not retained.

The Test Case Generator 340 is the component which takes the resulting sets of test sequences output by the Sequence Extractor 330 and automatically translates them into test case programs 180 that are executable by the Test Engine 350.

The Test Case Generator 340 also generates part of the Data Handler 360 providing valid and invalid data sets to the test case programs, as well as validate functions needed to check data. The Test Case Generator 340 automatically inserts calls to the Data Handler 360 and to the Logger 370.

Furthermore, the Test Case Generator 340 is arranged to convert the special labels that appear in the Usage Models into corresponding call functions in order to ensure that the system sets itself in the correct state when confronted with non-deterministic responses to a given stimulus.

The key function of the test case generator 340 is to convert the test sequence to an executable test program 180 in some programming language such as C++ or C# or an interpretable scripting language such as Perl or Python. To perform this conversion, the following (additional) actions are carried out in the present embodiment, although not necessarily performed in the order described below:
Include logging statements. To calculate the statistics properly, it is crucial that all steps are properly logged. More detail regarding logging is provided below.
Include Timer. To ensure that a test case will not be blocked as a result of absence of responses, the test case generator automatically includes a timer that preserves the liveliness of test case execution. This is achieved by automatically cancelling the timer when the test case processes the expected response from the SUT; and automatically starting the timer as the last operation before a transition to a (test case) state where the timer will be cancelled.
   In case the timer expires and fires, then it is automatically ensured that the test case is stopped properly, and that a failure is logged. In addition, all actions to clean up are performed and that the next test case will be started.
Generate the interface to the data handler component with the data validation functions and the data constructor functions as described below.
Include the invocations to the data validation functions and the data constructor functions at the appropriate places in the test sequence as described below.

The test router 182, as shown in FIGS. 8 and 19, is arranged to provide interfaces to the SUT and “routes” the calls (call instructions) from the test case to the correct interface of the SUT and vice versa. The test router provides the interfaces to the adapter components which represent the environmental model in which the SUT operates. It also provides the interface to the test case programs. The functionality of the test router is merely “routing” calls from the adapters to the test case and vice versa.

The Test Router 182, like the Adaptors 184, is SUT specific. However, unlike the Adaptors 184, the Test Router 182 may be generated fully automatically from the formal Interface Specifications of the interfaces to the Adaptors (i.e. the interfaces to the SUT which cross the test boundary). The following additional information provides an example of how to fully automate the generation of the Test Router. A person skilled in the art will appreciate that other methods may be used.

Referring to software testing context shown in FIG. 7, equivalents of the stimuli and responses (including their parameters) of the interfaces (ISUT, ITEST, IDEV1, IDEV2, and IDEV3) are present between the adapters 184 and the test router 182 as well as between the router 182 and the test case programs 180. A change to one of the Adaptor 184 interfaces must be reflected in the interfaces between the Test Router 182 and the Test Case programs 180 and Adaptors 184. In addition, the implementation of the Test Router must be changed to match the changed interfaces. Due to the number of interfaces, stimuli, and methods this is a non-trivial task, and when implemented manually is prone to errors and expensive.

In one embodiment of the present invention it is possible to generate automatically all of the interfaces between test case and test router, and all the interfaces between the adapters and the test router. Thereafter, it is possible to generate the test router itself.

In the example below, the term “component” is used to mean the Test Router or the Adaptors. Where it is necessary to distinguish between them, the individual terms are used, An example component interface specification may have an interface signature as follows:

Stimuli:
ChannelA.MethodWWW (TypeA a, TypeB b)
   {Where ‘ChannelA’ is the name of the interface, and ‘MethodWWW’ is the function or event.}
ChannelA.MethodXXX (TypeC &c)
ChannelB.MethodYYY (TypeD d)+
ChannelB.MethodZZZ (TypeE &e, TypeF f, TypeG &g)+

Responses:
ChannelA.ReturnValuePPP
ChannelA.ReturnValueQQQ
ChannelACB.CallbackAAA (TypeD d, TypeE e)
ChannelB.NullRet
ChannelBCB.CallbackBBB (TypeF f)
   where:
The stimuli on channel A are synchronous methods that return either of the following return values: ReturnValuePPP or ReturnValueQQQ;
MethodXXX even has a parameter that is by reference (an out-parameter);
the stimuli on channel B are also synchronous methods that return NulIRet (“void”) as indicated by the “+”;
MethodZZZ has a parameter that is by value and it has a parameter that it passes by reference; and
CallbackAAA and CallbackBBB are called Callbacks. These are method interfaces which are invoked asynchronously via messages place into a queue. These interfaces are said to be decoupled because the caller is not synchronised to the completion of the action as is the case for other method invocation.

The responses show the possible return values as well as the call-backs. The call-backs only contain input parameters since they cannot return output parameters.

An interface implemented by the test router 182 and used by the test case programs 180 may have the following interface signature:

Stimuli:
ITestRouter.ChannelA_ReturnValuePPP+
ITestRouter.ChannelA_ReturnValueQQQ+
ITestRouter.ChannelA_RetVal_MethodXXX (TypeC c)+
ITestRouter.ChannelA_RetVal_MethodZZZ (TypeE e, TypeG g)+
ITestRouter.ChannelACB_CallbackAAA (TypeD d, TypeE e)+
ITestRouter.ChannelBCB_CallbackBBB (TypeF f)+

Responses:
ITestRouter.NullRet
ITestRouterCB.ChannelA_MethodWWW (TypeA a, TypeB b)
ITestRouterCB.ChannelA_MethodXXX (TypeC c)
ITestRouterCB.ChannelB_MethodYYY (TypeD d)
ITestRouterCB.ChannelB_MethodZZZ (TypeE e, TypeF f, TypeG g)

As shown above, the stimuli have become responses, and vice versa. Also, the stimuli on the original interface have been changed to Callbacks. This enables the Test Router 182 to remain active and responsive to the Adaptors 184 while sending responses to the test case programs 180. An interface implemented by the Test Router and used by the Adaptors may have the following interface signature:

Stimuli:
IAdapter.ChannelA_MethodWWW (TypeA a, TypeB b)+
IAdapter.ChannelA_MethodXXX (TypeC c)+
IAdapter.ChannelB_MethodYYY (TypeD d)+
IAdapter.ChannelB_MethodZZZ (TypeE e, TypeF f, TypeG g)+

Responses:
IAdapter.NullRet
IAdapterCB.ChannelA_RetVal_MethodWWW_ReturnValuePPP
IAdapterCB.ChannelA_RetVal_MethodWWW_ReturnValueQQQ
IAdapterCB.ChannelA_RetVal_MethodXXX_ReturnValuePPP (TypeC c)
IAdapterCB.ChannelA_RetVal_MethodXXX_ReturnValueQQQ (TypeC c)
IAdapterCB.ChannelB_RetVal_MethodZZZ (TypeE e, TypeG g)
IAdapterCB.ChannelACB_CallbackAAA (TypeD d, TypeE e)
IAdapterCB.ChannelBCB_CallbackBBB (TypeF f)

As can be seen, the “direction” of the stimuli and responses has not changed as compared to the original interface. However, all stimuli have become “void” stimuli (by adding the “+”) as the test case 180 will return the required return value. As the adapter interface is blocked in such cases all return values must be reported to the adapter using a call-back so that the Test Router 182 and Adaptors 184 are decoupled.

When the interface of the test router 182 is specified and implemented as described above, the test case generator 340 only needs to know the following:
The channelname containing the stimuli of the test router (e.g. TestRouter).
The channelname containing the responses (call-backs) of the test router (e.g. TestRouterCB).
The channelname(s) containing the stimuli of the interfaces as used in the usage model.
The channelname(s) containing the responses of the interfaces as used in the usage model The usage model will contain the following keywords driving the interface generation as mentioned above:
SourceAPI which denotes the interface containing the stimuli of the component interface as used in the usage model. This keyword must be specified for each interface individually.
SourceCB which denotes the interface containing the responses of the component interface as used in the usage model. This keyword must be specified for each interface individually.
TargetAPI which denotes the interface containing the stimuli of the test router.
TargetCB which denotes the interface containing the responses of the test router.

As such, when given the Usage Model and the complete set of interfaces (in the example in FIG. 7 these are ISUT, ITEST, IDEV1, IDEV2 and IDEV3), the implementation of the Test Router is generated fully automatically.

The Adapters 184 represent the models of the environment in which the SUT 30 is operating. In FIG. 19 the Adapters 184 are shown for the three devices the SUT is controlling, as well as the Adapter for the client using the SUT. Depending on the environment there may be several of these Adapters. Each of the Adapters 184 will implement the corresponding interface and since the Adapters are developed using ASD they are guaranteed to implement the interface correctly and completely.

The Test Router 182, Data Handler 360, and Logger 370 form what is called “a CTF execution environment”. The Test Engine 350 manages the initialization of the CTF execution environment and the execution of the Test Case Programs 180. It also provides a user interface where the Test Engineer can track the progress of the execution, along with the results.

The Data Handler 360 component provides the test cases with valid and invalid data sets, as well as validate functions to check data. When executed by the Test Engine, the test case programs are combined with an appropriate selection of valid and invalid datasets and then passed to the SUT by the Test Router via the Component Interfaces and Test Interface. Data that comes from the SUT is automatically validated for correctness.

The functionality of the CTF system as described so far has focused only on test case generation in terms of stimuli and responses. Given the example of the home entertainment system, the usage models that are verified for correctness and completeness ensuring that only correct test sequences are generated.

The data handlers 360 determine how data within a system-under-test is handled by the CTF system. For example, when considering a sampled test sequence where the “record” button is pressed on the IHES interface resulting in signalling the DVD recorder that a program must be recorded, the CTF firstly checks whether the “record” button press on the IHES interface will result in a “start recording” command on the IDVD interface. However, it is also important to check that, when channel 7 is turned on, that it is channel 7 which is now recorded. In other words, not only the sequence of commands must be verified by the CTF, but also the contents of these commands in terms of parameters must be verified by the CTF 150. This process is referred to as data validation and the software functions which perform these actions are called data validation functions.

The data used for test purposes will be specific to the SUT 30. It is, therefore, impossible to automatically generate the implementation of such data validation functions; they must be programmed manually. However, when given the commands and the direction of parameters, i.e. whether it is input and/or output, it is possible to automatically generate the interface containing such data validation functions, and include the function invocation to these data validation functions at the appropriate places in the test sequence.

When the CTF system 150 is invoking a stimulus on the SUT 30, this stimulus must contain proper data, otherwise the SUT may react unexpectedly, resulting in non-compliant behaviour provoked by the CTF system 150 itself. Therefore, prior to invocation of a stimulus to the SUT 30, the parameters of this stimulus must be properly constructed. The process of constructing such parameters is referred to as data construction and the software functions which perform these actions are called data constructor functions. Parameters in this sense are also called arguments, and are typically the input of a function. Consider the example of y=sin (x), where x is then the parameter or argument of the sinus function. A parameter is considered as input when it is needed at the start of the function, the parameter is considered as output when it only becomes available at the end of the function, and the parameter is considered as both input and output when it is needed at the start of the function and when it has (possibly) changed at the end of the function, respectively.

Since the data is specific to the SUT 30 it is also impossible to automatically generate the implementation of such data constructor functions; these must be programmed manually. However, when given the commands and the direction of parameters, i.e. whether it is input and/or output, it is possible to automatically generate the interface containing such data constructor functions, and include the function invocation to these data constructor functions at the appropriate places in the test sequence.

The data handler component provides an implementation for the data validation functions as well as the data constructor functions. As mentioned above, these implementations need to be programmed manually only once.

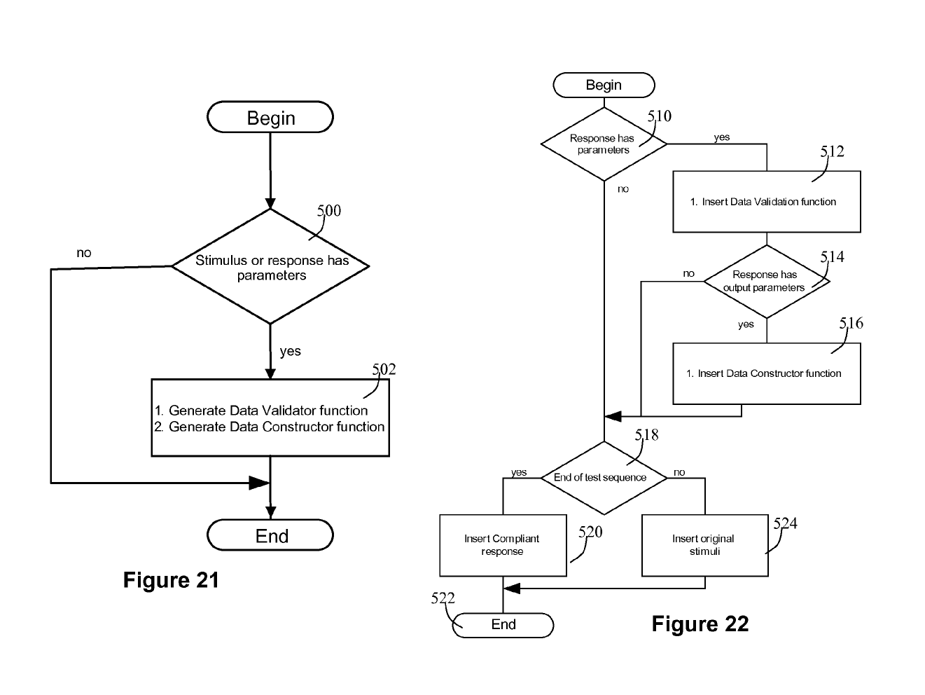

The algorithms, as described below, explain how and where the data validation functions and the data constructor functions are invoked. FIG. 21 shows how each stimulus and response on the interfaces crossing the test boundary is examined, at step 500, to ascertain if the stimulus has one or more parameters (either input or output). If the answer is YES, then the data handler interface containing the respective data validation function and the data constructor function for this stimulus or response is automatically created, at step 502. If the answer is NO, step 502 is bypassed.

FIG. 22 shows how for each response (from SUT to test sequence) on the interfaces that cross the test boundary, the data validation function and/or the data constructor function are processed.

The CTF determines, at step 510, whether the response (from SUT to test sequence) has parameters and if so, the invocation to the data validation function is inserted, at step 512. The outcome of invoking this data validation function is either a success, in which case the test sequence continues, or a failure, in which case the test sequence stops and returns a non-compliancy.

The response is then checked, at step 514, to ascertain if it has any output parameters. If the answer is YES, then invocation to the data constructor function is also inserted, at step 516, to ensure that the test sequence is able to construct a proper data value that must be returned from the test sequence to the SUT. An output parameter must be available at the end of the function and must be constructed properly by the callee. In one embodiment, it is the test sequence itself constructs the output parameter.

It is then determined, at step 518, whether the end of the test sequence has been reached. If YES, the response is inserted, at step 520, and the test sequence ends, at step 522. Otherwise the original stimuli from the usage model are inserted, at step 524, and the next response in the test sequence is processed.

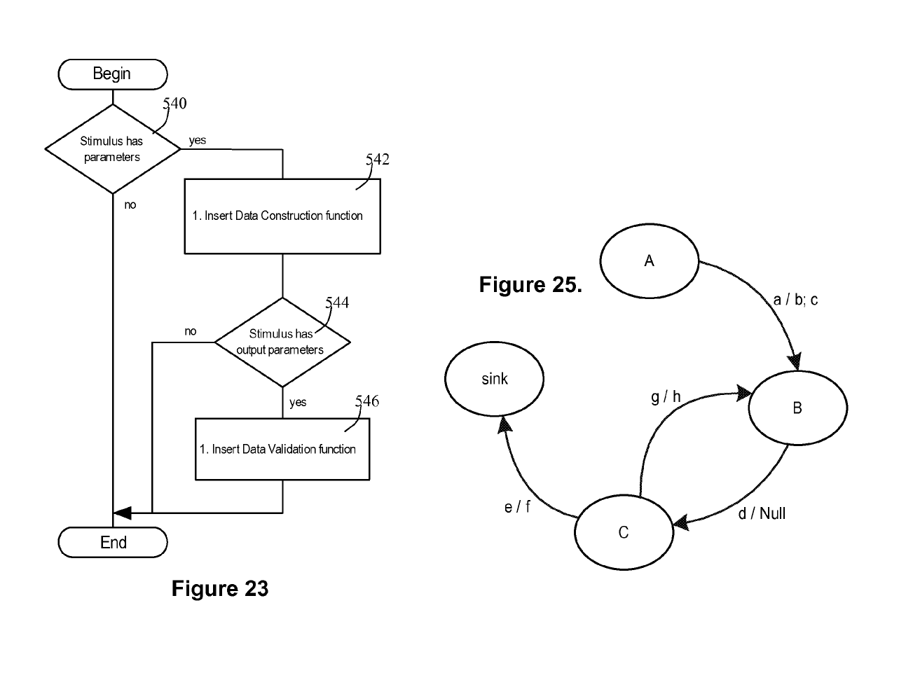

The stimuli also require processing and the process for this is described in relation to FIG. 23. The data validation function and/or the data constructor function are processed for each stimulus (from test sequence to SUT) on the interfaces that crosses the test boundary.

Firstly, it is determined, at step 540, whether the stimulus (from test sequence to SUT) has parameters and if the answer is YES, the invocation to the data constructor function is inserted, at step 542, to ensure that the test sequence is able to construct a proper data value that must be returned from the test sequence to the SUT.

The stimulus is then checked, at step 544, to ascertain if it has any output parameters. If the answer is YES, then invocation to the data validation function is also inserted, at step 546. If the answer is NO, step 546 is bypassed.

The outcome of invoking this data validation function is either (1) a success, in which case the test sequence continues or (2) a failure, in which case the test sequence stops and returns a non-compliancy.

An example method of implementing the data handler 360, is described below with reference to FIG. 19.

As shown, the test case 180 communicates with the SUT using the component interfaces through the test router 182 and the adapters 184. The only direct communication between SUT 150 and test case 180 is using the test interface(s) of the SUT. The component interfaces, as specified, may contain parameters that need to be dealt with. Two major data paths are identified:
1. Calls from the SUT on the component interfaces. These calls will eventually result in decoupled calls from the test router to the test case. This means that all data as originally sent on the component interfaces must also be sent from the test router to the test case through these decoupled calls.
2. Calls from the test case to the SUT. These calls can either be a return value of a call originally performed by the SUT (which is now blocked and waiting for this return value) or they can be independent, possibly decoupled, calls. In case of a return value, it is also possible that one or more out-parameters must be provided on the original call as performed by the SUT. On this path, data is only involved in case of out-parameters on these (synchronous) calls.
   Alternatively, in case of independent, possibly decoupled, calls from test case to the SUT, it is possible according to the component interface specification that data needs to be passed on from test case to the SUT. On embodiment of the invention for data handling is described below. A person skilled in the art will appreciate other approaches are possible.

Data sent from the SUT to the Test Case Programs via the Adaptors may need to be checked for validity and/or stored for later reuse. Furthermore, data received from the SUT in the test case may need be checked in order to determine whether the SUT is correct.

The generated Test Case Programs will invoke stimulus specific data validation methods when the corresponding stimulus is called. Each such data validation method will have the same signature as the corresponding stimulus and it will return a validation result where “ValidationOK” means that the validation has been successful and “ValidationFailed” means it has failed, indicating a test failure for the SUT. The implementation of the data validation methods must be done by hand. However, empty data validation methods (known as stubs within the field of software engineering) are generated automatically and these always return “ValidationOK”. In those cases where needed where specific data validation actions must be performed the corresponding stubs will be updated by hand to implement the actual required data validation actions. This approach reduces the cost of implementing data validation methods.

Given an interface XXX with the following signature:
void Method (TypeA A, TypeB B).

Then the following default data validation method will be generated:
virtual ValidationResult Validate_XXX_Method (TypeA A, TypeB B)
{return ValidationOK}.

When the generated test case programs receive stimulus “Method” it will call this data validation method before continuing. If the data validation method returns ValidationOK, the test case program continues; otherwise it terminates to signal a test failure.

Sometimes, it is also necessary that data as received from the SUT must be stored so that it can be re-used later.

The test case generator will automatically generate “set” function stubs for all stimuli which are automatically called from within the validate function. Such a set function will have the same signature as the corresponding stimulus and it will return void. These generated stubs do nothing; in those cases where data must be stored for reuse, the corresponding stub must be updated and completed by hand.

Given an interface XXX with the signature:
void Method (TypeA A, TypeB B).

Then the following default set method will be generated:
virtual void SetData_XXX_Method (TypeA A, TypeB B) { }

As such, the following default validate method will be generated:

```
virtual Result Validate_XXX_Method (TypeA A, TypeB B)
{
  SetData_XXX_Method (A, B).
  return ValidationOK.
}
```

As mentioned above, it is also necessary to have the capability to sent data from test case to the SUT. Given an interface XXX with the following signature:
void Method (TypeA A, TypeB B).

Then the following method is generated on the interface of the data-handling component, for which it is mandatory to provide an implementation:
virtual void GetData_XXX_Method (TypeA &A, TypeB &B)=0.

The semantics of the GetData_XXX method are defined as follows: each invocation will result returning new data values (if applicable). For example, suppose that the SUT has two devices, which are each identified by a unique identifier then two subsequent invocations to the same method will result in returning two different and valid device identifiers. If necessary, the GetData functions should also allocate and/or initialize memory, which must be released when the garbage collector is called.

The data-handling component has additional methods to initialize and terminate, as well as a method to perform garbage collection which is necessary to clean-up between test cases and these are called by the generated Test Case Programs as needed:
void Initialize ( ),
void Terminate ( ).
void CollectGarbage ( ).

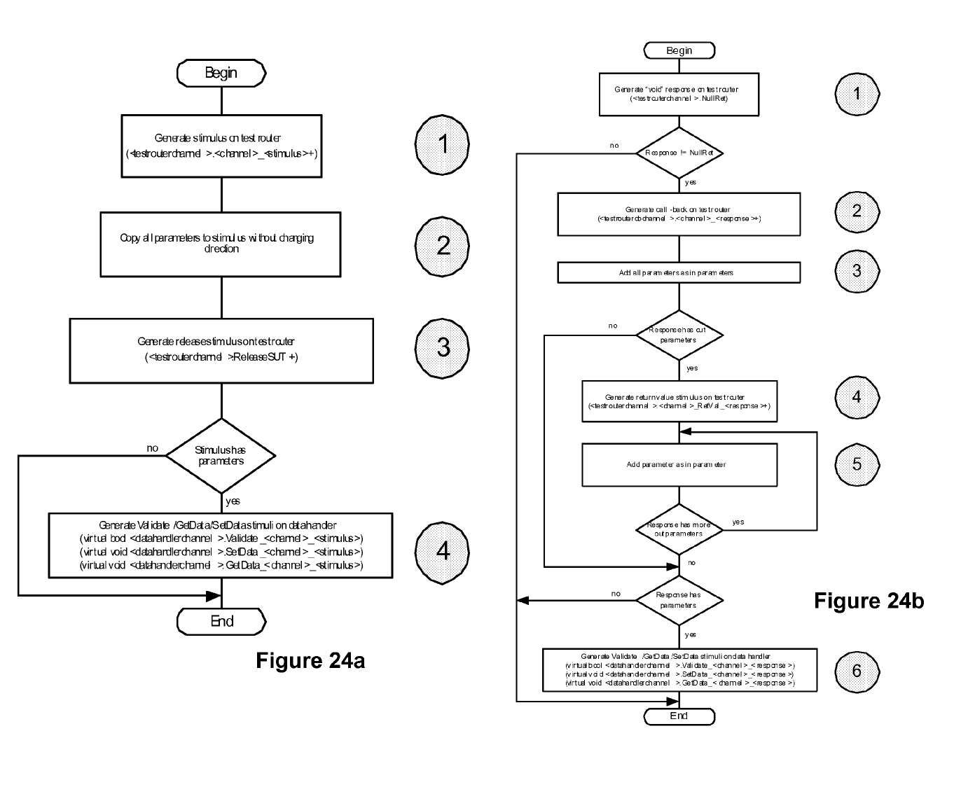

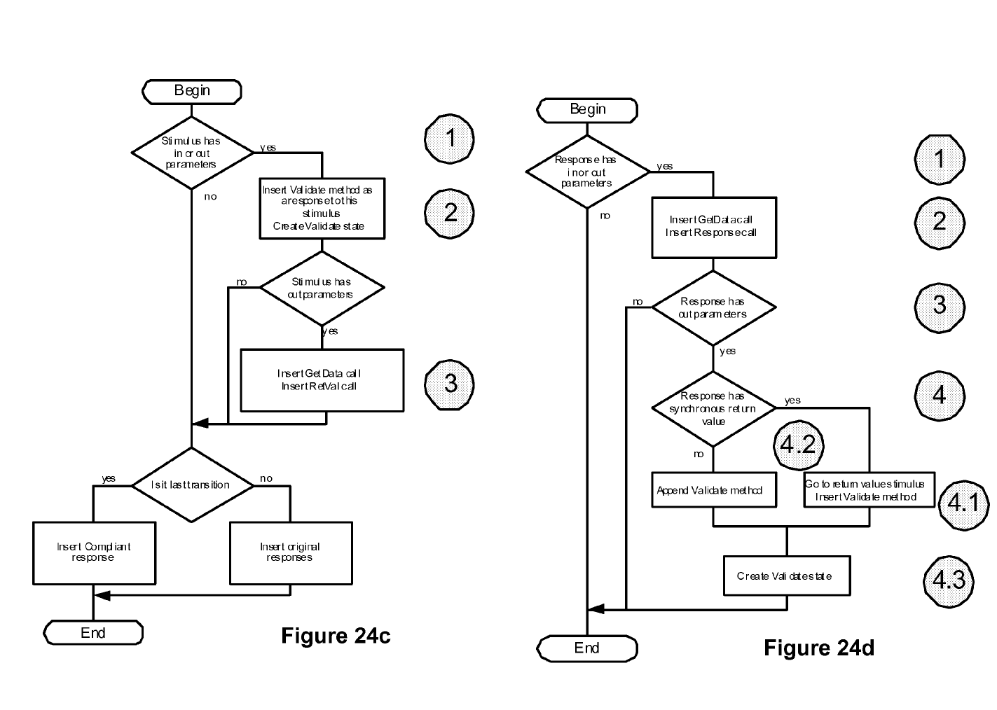

The test case generator 340 inserts all the data handling calls and generates the required interfaces in the embodiment of the invention described above. This is described in relation to various algorithms represented as flowcharts in FIGS. 24a to 24d.

Firstly, a correspondence collection between the original component interfaces API calls, called the source API, and test router API calls, called the target API, is created. The algorithm in FIG. 24a describes how to generate (i) the data handling calls and (ii) the calls to the test router.

The stimuli of the component interface(s) are generated into stimuli of the test router and are used as responses by the test cases. The processing for each stimulus on each source API is performed as shown in FIG. 24a.

The responses of the component interface(s) are generated into responses of the test router and are used as stimuli by the test cases. The processing for each response on each used source API is performed as shown in FIG. 24b.

The next step is to create a new state machine by parsing the generated test case sequence (for example, as shown in above with reference to the Logger and FIG. 25 below). It is important to realise that the role of stimuli and responses will swap: a stimulus in the usage model becomes a response in the test case, and vice versa.

This new state machine is parsed again and searched for the stimuli with parameters. The algorithm in FIG. 24c is used for every stimulus in every state (transition). The stimuli referred to in this algorithm are the stimuli after parsing the test case sequence. in other words, the stimuli as mentioned in this algorithm are the responses in the usage model.

If the stimulus has parameters then insert a Validate call as a first response and create a “Validate state” after the current one. All the responses to that stimulus should be moved into “Validate state” as responses to ValidationOK stimulus. The validate state is inserted to ensure a correct operation including parameter usage. If the stimulus is a so-called allowed stimulus and it has in or out parameters it is necessary to create a Validate state for the stimulus, check parameters for compliancy and in the case of positive validation (ValidationOK) return back to the original state where stimulus was originally called.

Furthermore, if the stimulus has out parameters then it is necessary to receive a GetData call retrieving the data, followed by a RetVal call returning it. If the stimulus has no parameters then insertion of the Validate call and “Validate state” is not needed.

Every “validate state” should have two pseudo stimuli ValidationOK and ValidationFailed. In the case of ValidationFailed it is necessary to return NonCompliant, and in the case of ValidationOK it is necessary to either continue execution of the test case (responses copied from the previous state must be executed here) or in the case of the last stimulus in the test case, it is necessary to return Compliant.

The state machine is parsed again for the responses with parameters. The algorithm shown in FIG. 24d is used for every response in every state. (The algorithm of FIG. 24c and the algorithm of FIG. 24d may be combined for the better performance, as only one loop is be needed). The responses as mentioned in the latter algorithm are the responses after parsing the test case sequence. In other words, the responses as mentioned in the later algorithm are the stimuli in the usage model.

For every response with parameters it is necessary to include “GetData call” prior to calling this response. It is necessary to validate only out parameters for responses, because it is necessary to ensure that the data received from SUT is correct data. If the response has “out” parameters there should be a Validate call and a Validate state as well. In this case it should be checked whether the response has a synchronous return value. if so, then the validate call can only be inserted when the return value has been seen. Note that according the ASD semantics there can be no more than one response having a synchronous return value and it must be the last one.

Finally, all source API stimuli and responses have to be replaced with the corresponding target API calls.

Returning to FIG. 19, the Logger component logs all the steps of all the Test Programs to ensure that all statistics can be calculated correctly after test case execution. To ensure that statistical data can be calculated after test case execution, it is crucial that all steps are properly logged. The data which needs to be logged properly includes each step as performed by the test case (this is called an ExecutionStep (ES)); and each state transition in the usage model as performed by the test case (this is called a JUMBLStep (JS)).

FIG. 25 shows a state diagram for a simple example usage model. This diagram is for illustration purposes only, and a person skilled in the art will appreciate that industrial scale software is much more complicated in real life.

The following sequence of steps reflects one of the test sequences which might be generated from this usage model.

Test Sequence 1
Call (a)/Wait (b); Wait (c)
Call (d)/null
Call (g)/Wait (h)
Call (d)/null
Call (e)/Wait (f)

The usage model is specified from the point of view of the system under test. Hence the stimuli are called from the test case(s) and the responses are awaited for by the test case(s).

The numbering of JUMBLSteps and ExecutionSteps is then as following for the given example:
JumblStep 1: “a/b;c”
   ExecutionStep 1: “a”
   ExecutionStep 2: “b”
   ExecutionStep 3: “c”
JumblStep 2: “d”
   ExecutionStep 4: “d”
JumblStep 3: “g/h”
   ExecutionStep 5: “g”
   ExecutionStep 6: “h”
JumblStep 4: “d”
   ExecutionStep 7: “d”
JumblStep 5—arc: “e/f”
   ExecutionStep 8: “e”
   ExecutionStep 9: “f”

The test case generator will automatically insert the logging calls into the generated test case programs at all required places and automatically ensure that the JUMBLSteps and/or ExecutionSteps are increased and reset to zero appropriately. An excerpt of a test log can be found in Appendix 1.

FIG. 15d shows the method steps involved in determining whether the quality goals have been reached, in order to assess the required level of reliability. This process relates to Step 116 of FIG. 7.

Every executed test case program will have an indication whether it passed or failed. The Test Result Analyser captures these results and draws conclusions about reliability and compliance based on statistical analysis. Part of the Test Result Analyser is based on existing technology, called JUMBL. These results together with the traces of the failed test cases are combined into the Test Report.

At the end of the test execution, the Test Report Generator will automatically collect all the logged data in order to generate a Test Report 600. The Test Report 600 will present: the number of test cases generated; the set of test cases that have succeeded; the set of test cases that have failed, including a trace that describes the sequence of steps up to the point where the SUT failed; the required software reliability and confidence levels; the measured software reliability; and the lower bound of the software reliability. With the given confidence level and the measured software reliability, it is also possible to calculate the lower bound of the software reliability.

An example test report may be found in Appendix 2. Along with the given reports, the report generator also generates compliance certificates for the SUT.

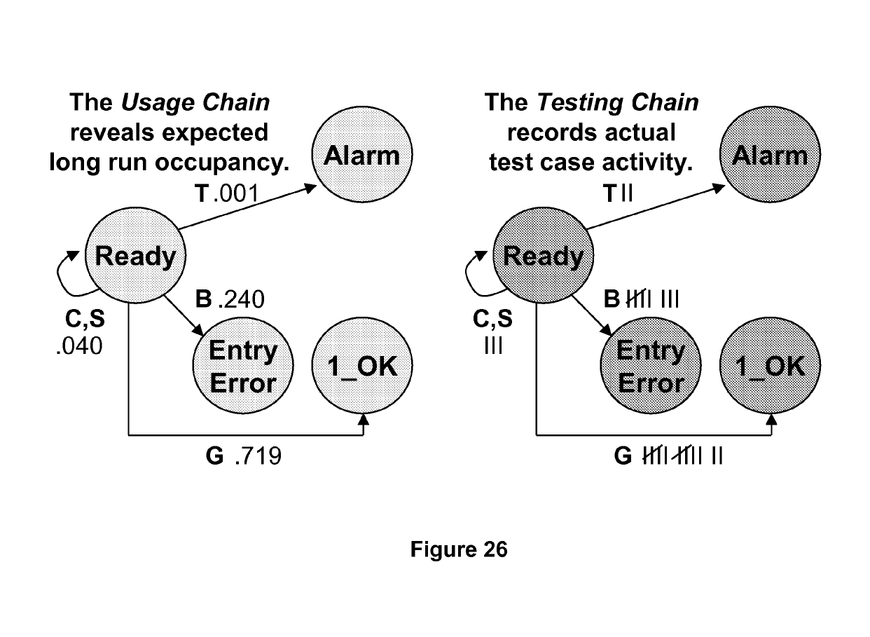

The measured reliability and confidence levels are computed from the accumulated statistical data and compared by the pre-specified Quality Targets 608 given as input. The test report 600 is generated automatically, at step 610, from the accumulated statistical data 456 and an expert assessment is made as to whether or not the target quality has been achieved. The expert assessment of the software reliability (described in greater detail below in relation to FIG. 26) is carried out, and it is determined, at step 620, whether the quality goals have been reached. If the answer is yes, testing is terminated, at step 630. If the answer is no, testing continues, at 450 (through point C of FIG. 15c).

Software Reliability is the predicted probability that a randomly selected test sequence executed from beginning to end will be executed successfully. In the JUMBL Test Report (Appendix 2), this is called the Single Use Reliability.

The statistical approach used by the CTF produces an estimated (predicted) software reliability of the SUT with a margin of error. The smaller this margin, the closer the estimated software reliability of the SUT will be to the actual software reliability as experienced during normal operational conditions over the long term. This margin of error is determined by a specified confidence level C and this in turn determines the number of test cases to be executed in each random test set.

The SRLB (Software Reliability Lower Bound) is an estimation for the lower bound of the estimated software reliability calculated from the specified confidence level C and the actual test results.

Given a specified confidence level C, the probability that the actual software reliability is lower than the lower bound=(1−C). For example, if C=95% and the result of executing a random test set is SRLB=83%, there is a 95% probability that the actual software reliability is in the range [83%, 100%]. Alternatively, there is a 5% probability that the actual software reliability is below 83%.

The minimum number of tests that are required in order to achieve a specified confidence level ( ) is given by the following formula:

$$t = ⌈ \frac{ln ( 1 - C [ \hat{R} ]}{ln \hat{R}} ⌉$$

where t is the minimum number of tests, and C[̂R] is the required confidence level.

Further information concerning confidence levels and intervals may be found in ‘Computations for Markov Chain Usage Models’ by S. J. Prowell, Technical Report UT-CS-03-505, and ‘Statistical Testing Notes’, Chapter 1: Testing Confidence Intervals by Jason M. Carter.

FIG. 20 illustrates how the point at which testing may be stopped is evaluated. Testing is stopped when one of two criteria is satisfied, in that either the target level of reliability has been reached with the specified level of confidence, or the testing results show that further testing will not yield any more information about this particular SUT.

The process by which JUMBL produces its results is that the TML model representing the predicate expanded Usage Model is transformed into a Markov Model. This represents runtime behaviour of a perfectly correct SUT, and is called the Usage Chain in FIG. 20.

As tests are executed, JUMBL builds a parallel Markov model based on the results of the tests actually executed. This is called the testing Chain in FIG. 20. This has the property that as randomly selected tests are passed, the Testing Chain becomes increasingly similar to the usage Chain. Conversely, the more randomly selected tests which fail, the less similar the Testing Chain becomes to the Usage Chain.

As each random test set is executed for the first time, the test results are fed into the Testing Chain to reflect the SUT behaviour actually encountered. When errors are detected, the SUT is repaired and this process invalidates the statistical significance of the random test sets already used. Therefore, after each repair, a new random test set must be extracted and executed. Previous test sets can be usefully re-executed as regression tests but when this is done, their statistical data is not added to the testing Chain when they are re-executed, as doing so would invalidate the measurements.

The dissimilarity between the Testing Chain and the Usage Chain is a measure of how closely the tested and observed behaviour matches the specified behaviour of the SUT. This measure is called the Kullback discriminant.

It is to be appreciated that a similar process/system which did not have the Usage Model Verification step would not be useful. The present inventors have recognised that testing is a statistical activity in which samples (sets of test cases) are extracted from a population (all possible test case as defined by the Usage Model) and used to assess/predict whether or not the SUT is likely to be able to pass all possible tests in the population. The essential elements of this approach are that every sample is a valid sample. That is, every test in a test set is a valid one according to the SUT specifications and the test sets are picked in a statistically valid way, and that the population (that is, the total set of test cases that can be generated from the Usage Model) is complete. If the population is not complete, there will be functionality/behaviours that are never tested, no matter how many tests are preformed.

The systems referred to herein are complex with the characteristics similar to those discussed, for example the home entertainment example. Thus the Usage Models describing their behaviour are typically large and complex. In practice, it is economically infeasible (if possible at all) to verify the Usage Model by hand by inspection.

The CTF is the only approach in which the Usage Model is automatically and mathematically verified for completeness and correctness. Without this verification, statistical testing loses its validity.

A person skilled in the art will appreciate that there are many different was to implement the concepts described above. For example, different coding languages may be used, and software could be written in different ways to achieve the same result. The following appendices describe different example implementations but these are not limiting examples.

In the described embodiments, multiple components may be arranged to provide a required functionality. However, such functionality may be provided by one or more functional components and the scope of the inventions as claimed is not to be limited by the functional components of the embodiments described providing such functionality. For example, one aspect of the invention includes a test execution means for executing a plurality of test cases corresponding to the plurality of test sequences. In the described embodiment, this functionality may be provided by the test engine in connection with the test router. However, other components may provide the functionality required. In another example, one aspect of the invention includes a test monitor means for monitoring the externally visible behaviour of the SUT as the plurality of test sequences are executed. This functionality may be provided by the test result analyser and report generator in one embodiment, or by a combination of the tree walker and test interpreter in another embodiment. A person skilled in the art will understand the functionality performed by the components described and will comprehend how to implement the required functionality on the basis of the described embodiments without being limited to the examples provided.

The terms ‘formal’ and ‘informal’ have a particular meaning within this document. However, it is to be appreciated that their meaning in this document has no bearing on, and is not be restricted by how these terms are used elsewhere.

A person skilled in the art will appreciate that alternatives to JUMBL exist or could be created in order to fulfil the task of the sequence extractor. In addition, if an alternative to JUMBL is to be used, it is conceivable that the input format to such an alternative may not be TML. In that case, the TML generator may be replaced with an alternative converter. Or alternatively an additional converter to the desired input format may be introduced. In any even, the steps of expanding the predicates would still need to be performed in a manner equivalent to that described. Similarly, it would be necessary to adapt the test case generator to accept the output of the JUMBL alternative as the format of its output would also likely be different. Finally, it may also be necessary to adapt the test result analyser and report generator 380. However, none of these changes alter the basic principles of the inventions and a person skilled in the art will appreciate the variations which may be made.

It is to be appreciated that the handling of non-determinism described in the present embodiments relates to the four types of specific non-determinism described herein. Other types of non-deterministic behaviour exist which may not be able to be handled by the embodiments of the present invention. Nevertheless, the ability to deal with any form of non-determinism is in itself a significant advance over the known methods in the art.

APPENDIX 1
This Appendix shows an excerpt from a Test Log

| | |
|---|---|
| | <?xml version=“1.0” encoding=“UTF-8” ?> |
| | <!-- These are the results of the test case execution --> |
| \textcircled{1} | − <TestResults Name=“testrunKeltie” Date=“2008-07-11” Time=“00:30:56” User=“Leon |
| | Bouwmeester” DesiredConfidenceLevel=“0.9” |
| | DesiredReliability=“0.9” |
| | xsi:noNamespaceSchemaLocation=“X:\CustomerProjects\PMS_CXA_CTF\product\code\xml_schemas |
| | \statistical_logging.xsd” |
| | xmlns:xsi=“http://www.w3.org/2001/XMLSchema-instance”> |
| \textcircled{2} | − <UsedVersions> |
| | <UsageModel Name=“BeUmTest” VersionID=“0.10” /> |
| | <UsedInterface Name=“Used interface IBEFE” VersionID=“1.0G” /> |
| | <UsedInterface Name=“Used interface IBEIP” VersionID=“0.00” /> |
| | <SUTName Name=“Prototype Back-End” VersionID=“0.12” /> |
| | </UsedVersions> |
| \textcircled{3} | − <TestCase Num=“1” Executed=“true”> |
| | <Step JumblStep=“0” ExecutionStep=“0” MethodName=“ITestcaseExecute” /> |
| | <Step JumblStep=“1” ExecutionStep=“1” MethodName=“IBeTestQStartGetVersion” /> |
| | <Step JumblStep=“1” ExecutionStep=“2” MethodName=“IBeFeGetVersion” /> |
| \textcircled{4} | <Step JumblStep=“2” ExecutionStep=“3” MethodName=“IBeFeVersionOK” /> |
| | <Step JumblStep=“2” ExecutionStep=“4” MethodName=“IBeTestQCBVersionExchanged” /> |
| | <Step JumblStep=“3” ExecutionStep=“5” MethodName=“IBeTestQStartUseVersion” /> |
| | <Step JumblStep=“3” ExecutionStep=“6” MethodName=“IBeFeUseVersion” /> |
| | <Step JumblStep=“3” ExecutionStep=“7” MethodName=“IBeTestQCBUseVersionPerformed” /> |
| | <Step JumblStep=“4” ExecutionStep=“8” MethodName=“IBeTestQStartGetSystemType” /> |
| | <Step JumblStep=“4” ExecutionStep=“9” MethodName=“IBeFeGetSystemType” /> |
| | <Step JumblStep=“4” ExecutionStep=“10” |
| | MethodName=“IBeTestQCBGetSystemTypePerformed” /> |
| | <Step JumblStep=“5” ExecutionStep=“11” MethodName=“IBeTestQStartConnect” /> |
| | <Step JumblStep=“5” ExecutionStep=“12” MethodName=“IBeFeConnect” /> |
| | <Step JumblStep=“6” ExecutionStep=“13” MethodName=“IBeFeConnectRequestOK” /> |
| | <Step JumblStep=“7” ExecutionStep=“14” MethodName=“IBeFeCBConnectionRefused” /> |
| | <Step JumblStep=“7” ExecutionStep=“15” MethodName=“IBeTestQCBNotConnected” /> |
| | <Step JumblStep=“8” ExecutionStep=“16” MethodName=“IBeTestQStartPrepareForShutdown” |
| | /> |
| | <Step JumblStep=“8” ExecutionStep=“17” MethodName=“IBeFePrepareForShutdown” /> |
| | <Step JumblStep=“8” ExecutionStep=“18” MethodName=“IBeTestQCBPreparedForShutdown” |
| | /> |
| \textcircled{5} | </TestCase> |
| \textcircled{6} | − <TestCase Num=“10” Executed=“true”> |
| | <Step JumblStep=“0” ExecutionStep=“0” MethodName=“ITestcaseExecute” /> |
| | <Step JumblStep=“1” ExecutionStep=“1” MethodName=“IBeTestQStartGetVersion” /> |
| | <Step JumblStep=“1” ExecutionStep=“2” MethodName=“IBeFeGetVersion” /> |
| | <Step JumblStep=“2” ExecutionStep=“3” MethodName=“IBeFeVersionOK” /> |
| | <Step JumblStep=“2” ExecutionStep=“4” MethodName=“IBeTestQCBVersionExchanged” /> |
| | <Step JumblStep=“3” ExecutionStep=“5” MethodName=“IBeTestQStartUseVersion” /> |
| | <Step JumblStep=“3” ExecutionStep=“6” MethodName=“IBeFeUseVersion”/> |
| | <Step JumblStep=“3” ExecutionStep=“7” MethodName=“IBeTestQCBUseVersionPerformed” /> |
| | <Step JumblStep=“4” ExecutionStep=“8” MethodName=“IBeTestQStartGetSystemType” /> |
| | <Step JumblStep=“4” ExecutionStep=“9” MethodName=“IBeFeGetSystemType” /> |
| | <StepJumblStep=“4”ExecutionStep=“10” MethodName= |
| | “IBeTestQCBGetSystemTypePerformed” /> |
| | <Step JumblStep=“5” ExecutionStep=“11” MethodName=“IBeTestQStartPrepareForShutdown” |
| | /> |
| | <Step JumblStep=“5” ExecutionStep=“12” MethodName=“IBeFePrepareForShutdown” /> |
| | <Step JumblStep=“5” ExecutionStep=“13” MethodName=“IBeTestQCBPreparedForShutdown” |
| | /> |
| | </TestCase> |
| | − <TestCase Num=“11” Executed=“true”> |
| | <Step JumblStep=“0” ExecutionStep=“0” MethodName=“ITestcaseExecute” /> |

Notes
\textcircled{1} Identifies the test run, date and time of test execution, name of person executing the tests and the target reliability and confidence levels.
\textcircled{2} Identifies Usage Model name and version, and the formal interface specifications by name and version.
\textcircled{3} Identifies the first test case - number 1 in this case. Each subsequent line identifies the JUMBL step number assigned by the Test Case generator to each transition in the Usage Model.
\textcircled{4} One JUMBL step may result in more than one execution step. An execution step is an operation executed on one of the interfaces to the SUT or to the test environment. In this case, JUMBL step 2 consists of 2 execution steps.
\textcircled{5} End of test case number 1
\textcircled{6} Start of test case number 10

APPENDIX 2
This Appendix shows an example Test Report.

<?xml version=“1.0” encoding=“utf-8” ?>
− <TestResults Name=“testrunKeltie” Total=“22” Failures=“0” Not-executed=“0”
Date=“2008-07-11” Time=“00:30:56” Duration=“230”
User=“Leon Bouwmeester” Compliant=“true”
xsi:noNamespaceSchemaLocation=“X:\CustomerProjects\PMS_CXA_CTF\product\code\xml_schemas
\test_execution_report.xsd”
xmlns:xsi=“http://www.w3.org/2001/XMLSchema-instance”>
− <UsedVersions>
<UsageModel Name=“BeUmTest” VersionID=“0.10” />
<UsedInterface Name=“Used interface IBEFE” VersionID=“1.0G” />
<UsedInterface Name=“Used interface IBEIP” VersionID=“0.00” />
<SUTName Name=“Prototype Back-End” VersionID=“0.12” />
</UsedVersions>
<TestCase Num=“1” Executed=“true” />
<TestCase Num=“10” Executed=“true” />
<TestCase Num=“11” Executed=“true” />
<TestCase Num=“12” Executed=“true” />
<TestCase Num=“13” Executed=“true” />
<TestCase Num=“14” Executed=“true” />
<TestCase Num=“15” Executed=“true” />
<TestCase Num=“16” Executed=“true” />
<TestCase Num=“17” Executed=“true” />
<TestCase Num=“18” Executed=“true” />
<TestCase Num=“19” Executed=“true” />
<TestCase Num=“2” Executed=“true” />
<TestCase Num=“20” Executed=“true” />
<TestCase Num=“3” Executed=“true” />
<TestCase Num=“4” Executed=“true” />
<TestCase Num=“5” Executed=“true” />
<TestCase Num=“6” Executed=“true” />
<TestCase Num=“7” Executed=“true” />
<TestCase Num=“8” Executed=“true” />
<TestCase Num=“9” Executed=“true” />
<ReliabilityFigures DesiredConfidenceLevel=“0.9” DesiredReliability=“0.9”
SingleUseReliability=“0,632107886”
SingleUseOptimumReliability=“0,632107886” RelativeKullbackDiscriminant=“40391”
RelativeOptimumKullbackDiscriminant=“40391”
SoftwareReliabilityLB=“579306705.65” />
</TestResults>

1.-39. (canceled)

40. A computer-implemented method of formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the method comprising:
obtaining a usage model for specifying the externally visible behaviour of the SUT as a plurality of usage scenarios, on the basis of the verified interface specification;
verifying the usage model, using a usage model verifier, to generate a verified usage model of the total set of observable, required behaviour of a compliant SUT with respect to its interfaces;
extracting, using a sequence extractor, a plurality of test sequences from the verified usage model;
executing, using a test executor, a plurality of test cases corresponding to the plurality of test sequences;
monitoring the externally visible behaviour of the SUT as the plurality of test sequences are executed; and
comparing the monitored externally visible behaviour with an expected behaviour of the SUT.

41. The computer-implemented method as claimed in claim 40, wherein the SUT has a plurality of interfaces for enabling communication to and from a plurality of external components, the plurality of interfaces being specified formally as sequence-based specifications.

42. The computer-implemented method as claimed in claim 40, wherein the obtaining step comprises obtaining a usage model which specifies the usage model in sequence based specification (SBS) notation within enumeration tables, each row of a table identifying one stimulus, its response and its equivalence for a particular usage scenario.

43. The computer-implemented method as claimed in claim 42, wherein the obtaining step comprises obtaining a usage model in which the SBS notation has been extended, in the enumeration tables, to include one or more probability columns to enable the usage model to represent multiple usage scenarios.

44. The computer-implemented method as claimed in claim 42, wherein the SBS notation has been extended, in the enumeration tables, to specify a label definition, such that when a particular usage scenario in the usage table results in non-deterministic behaviour, each label definition has a particular action associated therewith to resolve the non-deterministic behaviour.

45. The computer-implemented method as claimed in claim 44, wherein the SBS notation has been extended, in the enumeration tables, to specify a label reference, such that when a particular usage scenario in the usage table results in non-deterministic behaviour, each label reference has a corresponding label definition within the enumeration table for resolving the non-deterministic behaviour.

46. The computer-implemented method as claimed claim 42, wherein the obtaining step further comprises obtaining a usage model which specifies an ignore set of allowable responses to identify events which may be ignored during execution of the test cases, depending on a current state in the usage model.

47. The computer-implemented method of claim 42, wherein the obtaining step comprises providing a usage model editor to enable the creation of the usage model.

48. The computer-implemented method as claimed in claim 40, wherein verifying step comprises:
generating a corresponding mathematical model from the usage model and the plurality of formalised interface specifications; and testing whether the mathematical model is complete and correct.

49. The computer-implemented method as claimed in claim 48, wherein the testing step comprises checking the mathematical model against a plurality of well-formedness rules which are implemented through a model checker.

50. The computer-implemented method as claimed in claim 40, further comprising translating the usage model into a Markov model representation which is free of history and predicate information such that in any given present state, all future and past states are independent of the present state.

51. The computer-implemented method as claimed in claim 50, wherein the extracting step uses Graph Theory for extracting the set of test sequences.

52. The computer-implemented method as claimed in claim 50, wherein the extracting step further comprises extracting a minimal coverage test set of test sequences which specify paths through the usage model, the paths visiting every node and causing execution of every transition in the usage model.

53. The computer-implemented method as claimed in claim 52, wherein the executing step comprises executing a plurality of test cases which correspond to the minimal coverage test set of test sequences and the comparing step comprises comparing the monitored externally visible behaviour of the SUT to the expected behaviour of the SUT for full coverage of all transitions in the usage model.

54. The computer-implemented method as claimed in claim 43, wherein the extracting step uses Graph Theory for extracting the set of test sequences and further comprises extracting a random test set of test sequences, the selection of the random test set of test sequences being weighted in dependence on specified probabilities of the usage scenarios occurring during operation.

55. The computer-implemented method as claimed claim 54, wherein the executing step further comprises executing the random test set and the comparing step comprises comparing the monitored externally visible behaviour of the SUT to the expected behaviour of the SUT.

56. The computer-implemented method as claimed in claim 54, wherein each usage scenario is attributed with a plurality of probabilities depending on different operating conditions to be tested.

57. The computer-implemented method as claimed in claim 55, wherein the random test set is sufficiently large in order to provide a statistically significant measure of the reliability of the SUT, the size of the random test set being determined as a function of a user-specified reliability and confidence level.

58. The computer-implemented method as claimed in claim 40, further comprising converting the extracted set of test sequences into a set of executable test cases in an automatically executable language.

59. The computer-implemented method as claimed in claim 58, wherein the automatically executable language is a programming language or an interpretable scripting language.

60. The computer-implemented method as claimed in claim 59, wherein the interpretable scripting language is selected from Perl or Python.

61. The computer-implemented method as claimed in claim 41, wherein the executing step comprises routing the plurality of test cases through a test router, the test router being arranged to route call instructions from the plurality of test cases to a corresponding one of the plurality of interfaces of the SUT.

62. The computer-implemented method as claimed in claim 61, further comprising generating the test router automatically on the basis of the formal interface specifications for the plurality of interfaces to the SUT which cross the defined test boundary.

63. The computer-implemented method as claimed in claim 61, further comprising specifying the test router formally as a sequence based specification, which is verified for completeness and correctness.

64. The computer-implemented method as claimed in claim 40, further comprising developing a plurality of adapter components to emulate the behaviour of a corresponding external component which the SUT communicates with, wherein the adapter components are specified formally as sequence based specifications, which are verified for completeness and correctness.

65. The computer-implemented method as claimed in claim 40, wherein the test boundary is defined as being the boundary at which the test sequences are generated and at which test sequences are executed, and the method further comprises establishing the test boundary at an output side of a queue which decouples call-back responses from the external components to the SUT.

66. The computer-implemented method as claimed in claim 40, wherein the test boundary is defined as being the boundary at which the test sequences are generated and at which test sequences are executed, and the method further comprises establishing the test boundary at an input side of a queue which decouples call-back responses from the external components to the SUT.

67. The computer-implemented method as claimed in claim 40, wherein the test boundary when defined as a test boundary where the tests are generated, and when defined as a test and measurement boundary where the test sequences are executed, are located at different positions with respect to the SUT, and the method further comprises monitoring signal events which indicate when the SUT removes events from a queue which decouples call-back responses from the external components to the SUT, in order to synchronise test case execution, and using the removed events to reconcile the difference between the test boundary and the test and measurement boundary to ensure that these boundaries are matched.

68. The computer-implemented method as claimed in claim 40, further comprising generating, from the verified usage model and a plurality of used interface specifications, a tree walker graph in which paths through the graph describe every possible allowable sequence of events between the SUT and its environment, wherein a used interface is an interface between the SUT and its environment.

69. The computer-implemented method as claimed in claim 68, wherein the comparing step comprises considering events in the test sequence, traversing the tree walker graph in response to events received in response to execution of the test sequence, and distinguishing between ignorable events arriving at allowable moments which can be discarded, required events arriving at expected moments and which cause the test execution to proceed, and events that are sent by the SUT when they are not allowed according to the tree walker graph of the interface, which represent noncompliant behaviour.

70. The computer-implemented method as claimed claim 69, further comprising receiving an out of sequence event from the SUT that is defined in the tree walker graph as allowable and storing the out of sequence event in a buffer.

71. The computer-implemented method as claimed claim 70, further comprising checking the buffer each time the test sequence requires an event from the SUT, to ascertain whether the event has already arrived out of sequence, and when an event has arrived out of sequence, removing that event from the buffer as though the event has just been sent, and proceeding with the test sequence.

72. The computer-implemented method as claimed in claim 40, wherein the executing step comprises further comprises receiving valid and invalid test data sets, and using a data handler to ensure that test scenarios and subsequent executable test cases operate on realistic data during test execution.

73. The computer-implemented method as claimed in claim 72, wherein the executable test cases comprise a plurality of test steps, and the method further comprises
logging all the test steps of all the test cases in log reports in order to provide traceable results regarding the compliance of the SUT.

74. The computer-implemented method as claimed in claim 73, further comprising:
collating the data from the log reports of all the test cases from a random test set;
and generating a test report from the collated data.

75. The computer-implemented method as claimed in claim 74, further comprising:
accumulating statistical data from the test report; and
calculating a software reliability measure for the SUT.

76. The computer-implemented method as claimed in claim 40, wherein the comparing step further comprises: determining when the testing method may end by comparing a calculated software reliability measure against a required reliability and confidence level.

77. A computer system for formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the computer system comprising:
a usage model specifying the externally visible behaviour of the SUT as a plurality of usage scenarios, on the basis of the verified interface specification;
a usage model verifier for verifying the usage model to generate a verified usage model of the total set of observable, required behaviour of a compliant SUT with respect to its interfaces;
a sequence extractor for extracting a plurality of test sequences from the verified usage model;
a test executor for executing a plurality of test cases corresponding to the plurality of test sequences;
a test monitor for monitoring the externally visible behaviour of the SUT as the plurality of test sequences are executed; and
a test analyser for comparing the monitored externally visible behaviour with an expected behaviour of the SUT.

78. A computer system for automatically generating a series of test cases for use in formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the computer system comprising:
a usage model specifying the externally visible behaviour of the SUT as a plurality of usage scenarios, on the basis of the verified interface specification;
a usage model verifier for verifying the usage model to generate a verified usage model of the total set of observable, expected behaviour of a compliant SUT with respect to its interfaces;
a Markov model generator for generating a Markov model of the verified usage model;
a sequence extractor for extracting a plurality of test sequences from the verified usage model; and
a test executor for executing a plurality of test cases on the SUT corresponding to the plurality of test sequences.

79. A computer system for formally testing a complex machine control software program in order to determine defects within the software program, wherein the software program to be tested (SUT) has a defined test boundary, encompassing the complete set of visible behaviour of the SUT, and a plurality of interfaces between the SUT and a plurality of external components for enabling communication to and from the plurality of external components, each interface being defined in a formal, mathematically verified interface specification as a sequence-based specification, the computer system comprising:
a usage model specifying the externally visible behaviour of the SUT as a plurality of usage scenarios, on the basis of the verified interface specification, the usage model specifying the usage model in sequence based specification (SBS) notation within enumeration tables, each row of a table identifying one stimulus, its response and its equivalence for a particular usage scenario; wherein the SBS notation in the enumeration tables specifies a label definition, such that when a particular usage scenario in the usage table results in non-deterministic behaviour, each label definition has a particular action associated therewith to resolve the non-deterministic behaviour;
a usage model verifier for verifying the usage model to generate a verified usage model of the total set of observable, required behaviour of a compliant SUT with respect to its interfaces;
a sequence extractor for extracting a plurality of test sequences from the verified usage model;
a test executor for executing a plurality of test cases corresponding to the plurality of test sequences;
a test monitor for monitoring the externally visible behaviour of the SUT as the plurality of test sequences are executed;
a test analyser for comparing the monitored externally visible behaviour with an expected behaviour of the SUT.

80. The computer system as claimed in claim 79, further comprising a tree walker graph generator, arranged to use the verified usage model and a plurality of used interface specifications to generate a tree walker graph in which paths through the graph describe every possible allowable sequence of events between the SUT and its environment, wherein a used interface is an interface between the SUT and its environment.

81. A computer-implemented method of formally testing a complex machine control software program in order to determine defects within the software program, wherein the software program to be tested (SUT) has a defined test boundary, encompassing the complete set of visible behaviour of the SUT, and at least one interface between the SUT and an external component, the at least one interface being defined in a formal, mathematically verified interface specification, the computer-implemented method comprising:
obtaining a usage model for specifying the externally visible behaviour of the SUT as a plurality of usage scenarios, on the basis of the verified interface specification;
translating the usage model into a Markov model representation which is free of history and predicate information such that in any given present state, all future and past states are independent of the present state;
verifying the usage model, using a usage model verifier, to generate a verified usage model of the total set of observable, required behaviour of a compliant SUT with respect to its interfaces;
extracting, using a sequence extractor, a plurality of test sequences from the verified usage model, the extracting step using Graph Theory for extracting the set of test sequences and the further comprising extracting a minimal coverage test set of test sequences which specify paths through the usage model, the paths visiting every node and causing execution of every transition in the usage model;
executing, using a test executor, a plurality of test cases corresponding to the plurality of test sequences;
monitoring the externally visible behaviour of the SUT as the plurality of test sequences are executed; and
comparing the monitored externally visible behaviour with an expected behaviour of the SUT.
